(19) United States
(12) Patent Application Publication
(10) Pub. No.: US 2026/0105117 A1
(43) Pub. Date: Apr. 16, 2026

(54) MACHINE LEARNING ASSISTED CONTENT GENERATION USING SEMANTIC HIERARCHY

(71) Applicant: Webflow, Inc., San Francisco, CA (US)

(72) Inventors: Nori Naka, Mamaroneck, NY (US); André de Oliveira, Toronto (CA); Tristan Kenneth Tarpley, Houston, TX (US); James Matthew Gawarecki, Franklin, TN (US)

(21) Appl. No.: 19/357,410

(22) Filed: Oct. 14, 2025

Related U.S. Application Data
(60) Provisional application No. 63/707,167, filed on Oct. 14, 2024.
(60) Provisional application No. 63/707,158, filed on Oct. 14, 2024.

(51) Int. Cl. G06F 16/958; G06N 20/00

(52) U.S. Cl. CPC G06F 16/958; G06N 20/00

(57) ABSTRACT

Methods, systems, and apparatus, including computer programs encoded on computer storage media, for generating webpage data. An example method includes receiving, by a server system and from a computing device, request data for content for webpage components associated with the website. The semantic hierarchy specified within a content management system for the webpage components is identified based on the request data. Based on the semantic hierarchy, the prompt data for trained machine learning (ML) models is generated. The prompt data comprises instructions for generating content data corresponding to the webpage components according to the semantic hierarchy. The prompt data is provided to the trained ML models to obtain output data for the content data. An instruction is provided to the computing device that, when received by the computing device, causes the computing device to display a representation of the content data.

### CROSS-REFERENCE TO RELATED APPLICATIONS

This application claims the benefit of U.S. Provisional Application Nos. 63/707,158 and 63/707,167, each filed on Oct. 14, 2024, the contents of which are incorporated by reference in their entirety.

### TECHNICAL FIELD

This disclosure generally describes technology relating to machine learning, and more particularly, to technology related to the integration of machine learning to cloud-based software platforms.

### BACKGROUND

Machine learning (ML) enables systems to learn from data and improve their performance without being explicitly programmed for every task. Rather than following predefined rules, ML systems build models based on patterns found in large datasets. These models may then make predictions, classify data, or perform decision-making tasks based on new, unseen data. ML may involve providing input data into a trained model, which processes the provided data to identify patterns or relationships within the data.

ML may involve several types of learning. For example, in supervised learning, a model is trained on labeled data, where both the inputs and desired outputs are known. The goal is to learn a mapping from inputs to outputs to make predictions on new, unlabeled data. As another example, in unsupervised learning, a model works with data that has no labeled outcomes. Another example is reinforcement learning, where a model learns by interacting with an environment and receiving feedback in the form of rewards or penalties. ML has applications across industries, including healthcare, finance, and consumer-focused technologies. In the context of healthcare, ML systems and techniques may be useful to predict diseases, analyze medical images, and provide other advantages.

Information retrieval systems typically receive a user query and match the query against an index constructed from a corpus of documents. The index may be created by parsing documents, extracting terms and features, and building data structures that map terms to document locations. Candidate results are identified using lexical signals such as term frequency, inverse document frequency, and field weighting, and are then ranked by relevance scores. ML may be used to automate and improve these stages, including query understanding, document representation, candidate generation, and ranking.

### SUMMARY

This disclosure relates to systems and techniques that enhance the reliability and efficiency of incorporating ML-generated content into complex, schema-driven website development production environments. The disclosed systems identify a semantic hierarchy natively specified within a content management system (CMS) for one or more webpage components. This pre-existing hierarchy, which defines the relationships, constraints, and abstraction levels of the components, is used as a foundational blueprint for the automated construction of constrained and context-aware prompts for the ML models. By grounding the generation process in the CMS content structure, ML-generated content is compatible with the target environment, improving the functioning of CMS compute elements by reducing or eliminating integration bugs and ensuring that ML-generated code can be deployed directly and safely into a live production setting.

The disclosed systems and techniques also enhance user productivity and reduce the learning curve associated with complex web design tools. This may be accomplished by generating content for various webpage components using one or more generative machine learning (ML) models. The generated content may align with the hierarchical structure of a webpage. For instance, a “main banner” receives a high-level introductory text, while subordinate components such as “feature cards” or “FAQ sections” receive more detailed supporting content.

For example, a system may receive request data from a computing device for generating content for multiple webpage components. The request data may specify one or more user requirements that define characteristics of the generated content to be populated within corresponding webpage components of a webpage. The webpage components may include multiple sections, with each section including specific elements such as a title, a body of text, or other suitable content. The system may further receive context data associated with the user request to provide additional information relevant to the generation process. The context data may represent, for instance, previous user interactions with the webpage, metadata associated with the current webpage or section that the user is working on, or historical data or preference data associated with the user. Additional examples of context data are discussed below.

The system also processes the received request data to identify a semantic hierarchy within the CMS corresponding to the multiple webpage components. The semantic hierarchy defines relationships among sections, subsections, and other suitable components, including interdependencies or logical or logistical associations or links across sections or subsections in the webpage. Based on the user request data and the identified semantic hierarchy, the described system or server generates prompt data that serves as input for one or more machine learning (ML) models. The prompt data includes instructions or requirements for generating content corresponding to the webpage components in accordance with the user request and the semantic structure. The system then provides the prompt data as input to the ML models and obtains output data generated by the ML models. The output data may subsequently be processed to produce an instruction that is transmitted to the computing device in response to the user request. Upon execution by the computing device, the instruction causes the computing device to display a representation of the generated content at respective locations associated with the corresponding webpage components in the webpage.

The system may receive subsequent user requests to modify, regenerate, select, or deselect one or more portions of the generated content corresponding to respective webpage components. These subsequent requests may be reprocessed by the described system or server using either the existing semantic hierarchy or an updated semantic hierarchy to generate revised content for the relevant components. The system may identify the updated semantic hierarchy within the CMS based on the subsequent requests and accompanying context data.

Additionally, the system may receive user feedback data derived from user interactions with the displayed content on the computing device. The user feedback data may then be analyzed and incorporated to guide or refine the generation of additional prompt data, thereby enabling iterative improvement and adaptive content generation aligned with user request data.

As described herein, “webpage components” encompasses various configurable and interrelated component units that represent the hierarchical and visual structure of a webpage. In other words, webpage components may refer to various elements, modules, or sections that collectively form a webpage, as well as any combination thereof. For example, a webpage component may correspond to a section, subsection, or other structural unit within the webpage. Each section may include one or more constituent elements, such as a title, a body of text, a biography, an image, or other relevant information suitable for the design or purpose of the webpage.

As described herein, “context data” generally refers to background or supplemental information associated with user request data. More specifically, the context data may include various types of contextual information, such as workspace context corresponding to the current webpage being edited by the user, metadata associated with the webpage components (e.g., section-level metadata for components identified in the user request, also referred to as “section metadata” below), metadata derived from user-specific historical or preference data stored within a respective domain of a multi-tenant database, or other suitable contextual information associated with the user request data.

A workspace context specifies information describing the state of an application at or around the time a user submits a baseline query. The workspace context may identify this state by specifying various types of information, such as the active page or route, an element or component selection, a component hierarchy snapshot, currently visible panels and settings, responsive breakpoints, recent authoring actions, a project-type label indicating the class of site being developed, among others. The workspace context may further include user-specific attributes such as a role or skill tier determined from historical interactions to tailor the level of detail in responses. Context data may further be obtained from a client-side software development kit (SDK), from server-side session state, or from both. In privacy-aware deployments, the collection process may redact user content while retaining structural identifiers sufficient for retrieval and answer construction.

Section metadata generally refers to data that defines the structure and organization of a webpage by specifying its sections and their respective functions. For example, section metadata may specify that a webpage includes a header section with a title and one or more navigation links, a body section containing text and one or more images, a price section presenting multiple pricing options, a testimonial section highlighting user feedback, a footer section with contact information and legal disclaimers, an about section briefly summarizing information associated with the webpage, a FAQ section including answers to a list of frequently asked questions, a contact section summarizes various contact methods associated with the webpage, etc. Section metadata may also define formatting attributes, such as whether a section supports rich media (e.g., embedded video) or dynamic content (e.g., user comments). Section metadata may further include other suitable data specifying the formatting, arrangement, or combination of potential content chunks in the CMS that constitute a candidate webpage.

Section metadata may be updated and/or inferred from a user's historical behavior or historical data stored in a multi-tenant database for the user. For example, if a user frequently builds event registration pages that include a countdown timer, an agenda section, and a speaker bio section, the system may learn this preference and automatically prioritize similar section arrangements in future webpage generations. This approach personalizes the generation process, reduces repetitive manual input, and aligns the generated webpages with the user's established design patterns.

The term “semantic hierarchy” generally refers to an ordered structure that defines semantic relationships among content elements of one or more webpage components in a webpage, across multiple webpage components of the webpage, or other suitable relationships or links in the webpage, based on their respective semantic meaning, context, and level of abstraction. In some implementations, the semantic hierarchy may be explicitly defined within context data (such as section metadata) or derived dynamically from user request data by the described system. The hierarchy establishes how information is conceptually organized (e.g., identifying which elements represent higher-level summaries, categories, or topics, and which elements provide supporting details, explanations, or examples).

In some implementations, the semantic hierarchy may describe parent-child or peer-to-peer relationships between webpage components and their corresponding content. For instance, a higher-level section may semantically encompass several subordinate subsections that elaborate on distinct aspects of the same or related concept, while individual content items within those subsections may further refine or illustrate high-level topics for those subsections. The semantic hierarchy may also express semantic dependencies between textual and non-textual elements (e.g., between a title and an associated image caption or between a summary paragraph and detailed lists). By infusing these semantic relationships into content generation using ML models, the system may generate content that maintains conceptual and logical coherence across the entire webpage.

In one general aspect, this disclosure is focused on a computer-implemented method that includes a set of operations. The operations include receiving, by a server system and from a computing device, request data for content for one or more webpage components associated with the website. The operations also include identifying, by the server system and based on the request data, a semantic hierarchy specified within a content management system for the one or more webpage components. Further, the operations include generating, by the server system and based on the semantic hierarchy, prompt data for one or more trained machine learning (ML) models. The prompt data includes one or more instructions for generating content data corresponding to the one or more webpage components according to the semantic hierarchy. Additional operations include providing, by the server system, the prompt data to the one or more trained ML models. The operations then include obtaining, by the server system and from the one or more trained ML models, output data for the content data. The operations also include providing, by the server system and to the computing device responsive to the request data, an instruction that, when received by the computing device, causes the computing device to display a representation of the content data.

One or more implementations may include the following optional features. For example, in some implementations, the one or more instructions may include an instruction specifying a desired complexity for the content data based on one or more semantic relationships specified in the semantic hierarchy.

In some implementations, the output data may include a plurality of content items that are each associated with a particular webpage component included in the one or more webpage components.

In some implementations, the operations may further include evaluating, by the server system, the plurality of content items of the output data; and determining, by the server system, that the output data is valid based on evaluating the plurality of content items.

In some implementations, evaluating the plurality of content items of the output data may include determining a complexity indicator associated with each content item included in the plurality of content items. Determining that the output data is valid includes determining that complexity indicators determined for content items included in the plurality of content items satisfies a specified complexity based on one or more semantic relationships specified in the semantic hierarchy.

In some implementations, evaluating the plurality of content items of the output data may include determining a linguistic indicator associated with each content item included in the plurality of content items. Determining that the output data is valid includes determining that linguistic indicators determined for content items included in the plurality of content items satisfies a specified consistency based on one or more semantic relationships specified in the semantic hierarchy.

In some implementations, the linguistic indicator may include a tone indicator.

In some implementations, the operations may further include receiving, by the server system, data indicating one or more user modifications to the representation of the content data. The operations may further include generating, by the server system and based on the semantic hierarchy, second prompt data for the one or more trained ML models. The second prompt data includes one or more additional instructions for generating the content data based on the one or more user modifications. The operations further include providing, by the server system, the second prompt data to one or more trained ML models. The operations also include obtaining, by the server system and from the one or more trained ML models, second output data for the content data. The operations then include providing, by the server system and to the computing device, a second instruction that, when received by the computing device, causes the computing device to display a modified representation of the content data.

In some implementations, the semantic hierarchy includes a plurality of semantic tiers. A first semantic tier is associated with a first webpage component, and a second semantic tier is associated with a second webpage component, where the first semantic tier represents semantic information at a higher level of abstraction than the second semantic tier.

In some implementations, the first webpage component includes a heading for a section of a webpage associated with the website, and the second webpage component includes a body of text for the section.

In some implementations, the semantic hierarchy includes a graph-based representation specifying hierarchical relationships among the one or more webpage components.

In some implementations, the operations further include embedding, by the server system, at least a portion of the request data into a vector representation. The operations also include determining, by the server system, a plurality of semantic similarity scores by comparing the vector representation to a plurality of vector representations corresponding to a plurality of content chunks stored in the content management system. Additional operations may include selecting, by the server system, as the semantic hierarchy, semantic information of the content chunks with semantic similarity scores higher than a threshold value.

In some implementations, the operations further include receiving, by the server system, feedback data representing a user action associated with the displayed representation of the content data; and processing, by the server system, the feedback data used for generating additional prompt data.

The subject matter described in this specification may be implemented to provide a range of technical advantages, effects, and benefits. For example, the disclosed systems and techniques enable efficient generation of content for various webpage components based on user request data and the semantic hierarchy represented by that request data. The generated content includes portions with varying levels of abstraction or complexity, each portion aligning with the semantic hierarchy of a corresponding webpage component, allowing the content to be smoothly integrated into semantically suitable locations on a webpage. Accordingly, the described content generation capabilities reduce manual design overhead, shorten development cycles, and enable scalable webpage production without sacrificing content quality or consistency.

To achieve these benefits, the described systems and techniques overcome limitations of conventional content generation systems by grounding ML-generated content in a semantic hierarchy derived from the user request data using the CMS system. The semantic hierarchy may be determined directly within the CMS or in association with information storage compatible with retrieval-augmented generation (RAG) techniques. Unlike open-ended generative systems that may produce unverified or hallucinated content, the disclosed approach ensures that content generated by ML models upon user requests aligns in level of abstraction, complexity, and/or style with the semantic hierarchy of the corresponding webpage components. To achieve this, the system processes the user request data to generate a semantic hierarchy specified within the CMS for the webpage components and then generates prompt data as input for one or more ML models based on the user request and the semantic hierarchy. The resulting prompt data encodes rich hierarchical information, thereby grounding the ML model outputs to exhibit an appropriate level of abstraction, complexity, or style consistent with the hierarchical context.

The disclosed techniques may determine the semantic hierarchy efficiently in various ways. In some implementations, the system determines the semantic hierarchy within the user request data by comparing the semantic similarity between the user request data and the hierarchical information stored in the CMS. The semantic similarity may be quantified by measuring the distance between the vector features of the user request data and the hierarchical information in a vector feature space. The system may then assign a respective level of semantic hierarchy to each portion of the user request data. In some implementations, the system stores hierarchical information associated with various webpage components in the CMS, enabling direct determination of hierarchical information for components (e.g., sections, subsections, titles, etc.) linked to the user request data stored in the CMS. In other implementations, the system determines the semantic hierarchy within the CMS based on both the user request data and additional context information. In such cases, the system may obtain vector features representing the context information and infuse them into the vector features of the user request data to determine semantic similarity with the hierarchical levels stored in the CMS.

The data, including the semantic hierarchy, stored in the CMS remains up to date and may be efficiently modified or updated to reflect the latest standards, policies, or product features. The CMS may maintain multimodal content (e.g., text, images, audio, video) segmented into discrete content chunks. Segmenting content enables incremental updates, allowing administrators to add, modify, or deprecate content chunks without performing a full re-indexing of the knowledge base. This reduces the propagation of stale or outdated information into webpages. The CMS may also record up-to-date metadata, source identifiers, and version histories to support retrieval methods that prioritize current content and avoid superseded entries.

The system may further incorporate user feedback (e.g., explicit ratings or implicit engagement metrics) to recalculate the semantic hierarchy within the CMS and to regenerate prompt data for instructing the ML models to produce semantically consistent content. The system is also robust to various user requests for different content types by implementing multi-modal ML models, such as multi-modal encoders and decoders, large language models (LLMs), or other suitable machine learning models.

Moreover, the disclosed systems and techniques may leverage ML models to continuously improve content generation for webpage components with varying levels of automation in an iterative manner. For instance, a user may issue a natural language request to add, change, or shorten content to multiple sections of a webpage, each having distinct topics and levels of abstraction. The system generates prompt data grounded in the user request and context data for use by an ML model to produce content aligned with the hierarchical level of the respective webpage components. The system may then validate the ML-generated content based on the semantic hierarchy stored in the CMS. Additionally, the system supports iterative content generation for user-selected portions or sections, deploys new content updates, and re-instantiates individual webpage components or sections without requiring regeneration of the entire webpage.

The details of one or more implementations of the disclosure are set forth in the accompanying drawings and the description below. Other features, objects, and advantages of the invention will be apparent from the description and drawings, and from the claims.

### BRIEF DESCRIPTION OF DRAWINGS

FIG. 1 illustrates an example of a technique for generating content for webpage components in a webpage in response to a user request according to semantic similarity using one or more ML models and a content management system.

FIG. 2 illustrates an example of a system that enables a web experience platform (WEP) for supporting web development using one or more ML models.

FIG. 3 illustrates an example of a user interface for generating content for webpage components in a webpage in response to a user request, according to semantic similarity, using one or more machine learning models and a content management system.

FIG. 4 illustrates a flow chart for an example of a process for generating content for webpage components according to semantic similarity using one or more ML models and a content management system.

In the drawings, like reference numbers represent corresponding parts throughout.

### DETAILED DESCRIPTION

This disclosure is focused on computer-implemented technology that improves the integration of ML into production environments by leveraging a semantic hierarchy specified within a CMS. This semantic hierarchy is used to construct constrained and context-aware prompts that ensure that resulting ML-generated content is compatible with schema requirements of the CMS. For example, a system may be configured to receive request data from a computing device that specifies a user's instructions for generating content for one or more webpage components. The request data may also identify a subset of webpage components for which content is to be generated, such as one or more sections, subsections, titles for sections or subsections, or corresponding bodies of text associated with those elements.

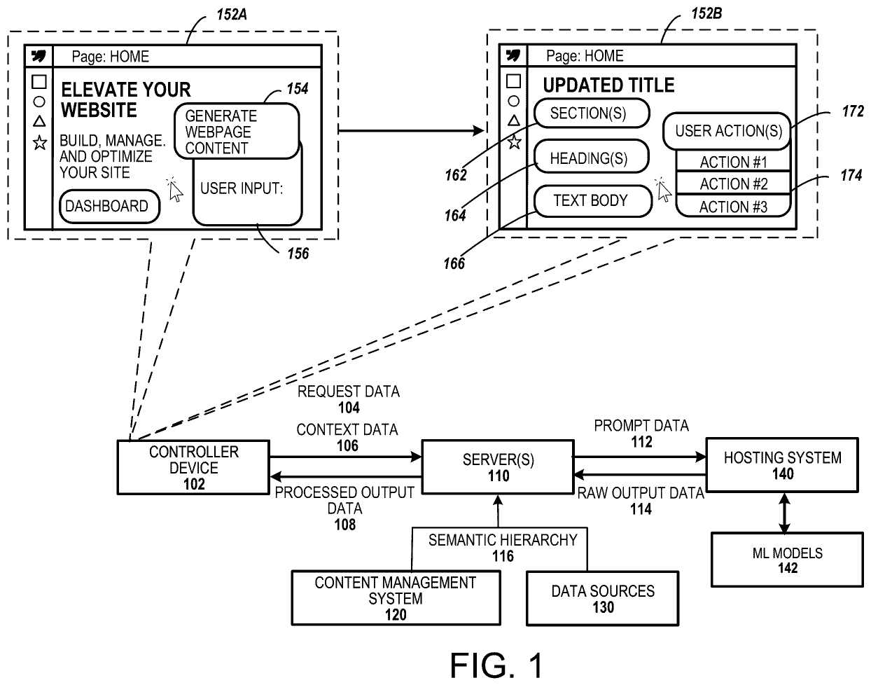

The system identifies a semantic hierarchy specified within a content management system (CMS) for one or more webpage components. The identification may be based on a similarity measure between vector representations (or “vector features”) of the webpage components in a vector space and vector representations of semantic hierarchy information stored in the CMS. The semantic hierarchy information may include content chunks associated with a semantic meaning and a corresponding semantic hierarchy tag or metadata. The semantic hierarchy information may indicate the relative level of abstraction or granularity within the hierarchy, such as a first tier, second tier, third tier, or other suitable tiers. In general, a lower numerical tier represents a higher hierarchical level characterized by greater abstraction and lower complexity. More details of the semantic hierarchy are described below in connection with FIG. 1.

The CMS may store semantic hierarchy information for the webpage components specified in the user request data, enabling direct identification of the relevant hierarchy without the need to compute semantic similarity. In some implementations, the CMS stores multiple content chunks, which may be pre-determined and/or pre-grouped according to semantic keywords, topics, or hierarchy information. Those keywords and topics stored in the CMS may be pre-linked to one or more different levels of hierarchy. Each content chunk in the CMS is embedded to produce a vector representation in a vector feature space, which is stored in one or more vector databases. At runtime, the system may enable the CMS to match a user request with the corresponding content chunks stored in the CMS based on a level of semantic similarity, as described above. The system may identify the hierarchy information of content chunks that are semantically similar to the user request data and set this hierarchy information as the semantic hierarchy for the user request data.

In other implementations, the user request data may represent or imply a semantic hierarchy that defines relationships across different webpage components. In such cases, the CMS may validate, refine, or modify the hierarchy indicated by the user request data and update the corresponding hierarchy information stored in the CMS to maintain consistency across related webpage components.

The system generates prompt data for one or more machine learning (ML) models based on the semantic hierarchy and receiving the user request data. The prompt data includes structured instructions for generating content corresponding to the identified webpage components in accordance with the semantic hierarchy. The prompt data may include parameters such as content type, tone, target abstraction level, component-specific context, or other suitable context to ensure alignment between the generated content and the hierarchical level of each component. The ML models may include multimodal models (e.g., multi-modal encoders and decoders), large language models (LLMs), or other suitable ML models configured for grounded content generation.

In some implementations, prompt data is additionally (or alternatively) be generated from historical and contextual data. Such prompt data may be aligned with the semantic hierarchy retrieved from CMS using RAG. Thus, ML-generated output using these types of prompt data is grounded in context beyond user input. This grounding improves the accuracy, relevance, and consistency of the ML-generated content used to populate the respective sections of the webpage templates.

The system may process the output generated by the ML model to verify or validate the generated content before returning it to the computing device. In some implementations, the system includes a fact-checking or validation module configured to determine whether the generated content satisfies one or more semantic requirements defined by the semantic hierarchy. For instance, the system may analyze individual content items within the output data to compute a complexity indicator and evaluate whether that indicator meets the specified complexity level associated with the corresponding semantic relationship in the hierarchy. Alternatively, or in addition, the system may evaluate each content item to determine a linguistic indicator and verify whether it satisfies a target linguistic consistency based on the semantic relationships specified in the semantic hierarchy.

The complexity indicator may generally represent the degree of detail or abstraction of a content item and may be derived from measurable features such as content length, sentence structure, information density, word count, or other suitable features. The complexity indicator may be expressed using a numerical value, categorical label, or other suitable representation. The linguistic indicator may represent tone, style, formality, or other linguistic aspects of the content, and may likewise be quantified or classified using a numerical value, categorical label, predefined category, or other suitable representation.

The system may further transmit an instruction to the computing device in response to the user's request for content data. The instruction may include one or more commands or structured data with the ML-generated content and positional metadata indicating the target locations of the ML-generated content within the webpage. Upon receipt and execution of the instruction, the computing device causes a graphical user interface (GUI) or web-design environment to render a representation of the content data in association with the corresponding webpage components.

In some implementations, the instruction may include references to styling parameters, formatting rules, or component identifiers stored in the content management system, thereby ensuring that the displayed content accurately reflects the hierarchical relationships and design context defined during generation. This process automates the creation of content for various webpage components in a webpage or website in a way that the content is both semantically consistent and structurally constrained by the schema requirements of the content management system.

The disclosed systems and techniques improve various aspects of webpage development, such as creating content for webpages within an authoring environment using ML. Generally, the user may interact with a software application on their client device that allows users to create, publish, and modify digital content without any coding experience. Users interact with this software application to manage websites, manage website content, and generate new website content regardless of technical expertise or skill level. The software application may provide a graphical user interface (GUI) on the client device that enables the user to create, edit, modify, and publish webpage content online.

The techniques described herein also improve upon contextual guidance provided by code generation systems. For instance, instead of merely retrieving information from a fixed knowledge base to guide a user's manual actions, the present disclosure describes a system that automates the generation of content for according to semantic hierarchy specified in the user request data. While some code generation systems utilize a passive knowledge base for informational retrieval, the disclosed systems leverage the CMS as an active, executable framework. This is achieved by constructing a prompt for an ML model that is specifically constrained by a set of web development tools and tasks that are native to the CMS. The system's awareness of the available tools, their development history, prior usage patterns, and the multi-tenant architecture of the platform allows it to generate a highly specific set of instructions for the ML model, moving beyond informational guidance to automated action.

The systems and techniques also leverage prompt construction techniques distinct from some code-generation platforms or “design-to-code” platforms, which typically generate code artifacts (e.g., HTML, CSS) in a relatively unconstrained context. Such platforms often lack deep awareness of the complex rules, schema, and historical context of a specific, pre-existing production environment, such as a multi-tenant CMS. In contrast, the prompt construction processes described herein are uniquely informed by a confluence of data sources. This includes the user's current visual context (e.g., a portion of the webpage the user is viewing and interacting with) and the current, pre-modification state and configuration of the specific webpage. The data sources also include the architectural and historical constraints of the underlying CMS, including the specific web development tools and tasks available to a particular user account and compatible with the target webpage. This multi-contextual awareness enables a high degree of automation within a complex environment, ensuring that the ML-generated code update segment is not only responsive to the user's natural language request but is also guaranteed to be compatible, executable, and consistent with the production environment, thereby avoiding the risks associated with deploying code generated in an isolated context.

In some implementations, users may receive another preview of generated webpage components based on the semantic hierarchy for review and confirmation. For example, users may provide feedback data to the system by selecting, deselecting, or modifying parts of the generated content. Additionally, or alternatively, the user may provide feedback data to the system by sending a subsequent request to regenerate content for multiple webpage components. The system may update hierarchy schemes stored in the CMS based on user feedback. In some cases, the system may incorporate user feedback into the vector features of the request data in the vector space to identify new semantic hierarchies. This enables the system to efficiently refine and update parts of the generated content and the semantic hierarchy stored in the CMS, as well as create new prompt data as input for ML models to produce new output data. data.

The system may modify user requests using various techniques to facilitate the identification of the semantic hierarchy and/or the generation of prompt data. For example, a user may provide an initial or original request captured from a graphical interface, such as a chat panel, a selection tool, or another ML interface. The system generates an updated request by modifying the initial user request based on context data, such as workspace context, user historical data, or other relevant context data, as described above. Refinement may include text normalization, disambiguation of element names according to context, insertion of project-type or layout terminology, or harmonization with a specific syntax or templating so that the CMS and the ML models may receive task-compatible input. Conversation threading and history tracking may be used so that follow-up requests may inherit context information without the user re-specifying prior details.

Referring to the RAG and CMS described above, the information retrieval techniques disclosed herein are directed to improvements to problems that uniquely arise in computer-related technology. As described herein, the techniques improve how networked computing systems retrieve and serve information under accuracy and latency constraints using specialized data structures and machine operations. This operates on machine-generated signals (e.g., workspace context captured from application state, content chunks with up-to-date metadata, high-dimensional vector representations stored in one or more vector databases) and applies computer-implemented processes (e.g., semantic similarity search, query expansion, prompt assembly) that condition ML models on retrieved passages and section metadata. These steps improve the functioning of the computer by reducing off-topic results, enforcing recency via CMS-managed updates, and meeting a defined end-to-end time threshold from query receipt to UI display. Manual analogs of these operations result in a fundamentally different process.

For instance, a person cannot observe and identify context data for webpage generation (e.g., workspace context, historical context, or other context data) within a specified time period (e.g., less than three seconds), compute nearest neighbors over multimodal embeddings, or orchestrate model routing and caching to satisfy timing imitations associated with the distributed services. The operations involved in the disclosed information retrieval techniques disclosed herein, therefore, address problems unique to computerized information retrieval (context loss, staleness, and scale) and constitute a specific improvement in the operation of computer systems.

Moreover, the information retrieval techniques disclosed herein involve elements specific to computer-related technology, such as vector databases and RAG, to generate information outputs. A vector database transforms heterogeneous source content into machine-optimized representations that enable sub-second retrieval for prompt construction and retrieval-augmented generation. Raw documents may be segmented into content chunks and passed through an embedding model that maps each chunk into a high-dimensional numeric vector whose coordinates encode semantic relationships. The database persists these vectors in specialized indexes, such as graph-or quantization-based nearest-neighbor structures with cache-aligned layouts, precomputed centroids, and distance metrics. A refined query may be embedded once and matched against millions of candidates in time budgets suitable for interactive use. Each stored vector is keyed to a source passage, up-to-date metadata, and version identifiers so the retriever may return current and authoritative chunks that may be injected into an ML prompt without additional parsing.

Data transformations involved in generating embeddings for storage in a vector database make them distinct from mental steps used by humans in storing information. Embeddings are opaque numeric arrays, and similarity search requires parallel numeric kernels over high-dimensional spaces, and the ranking policies that trade recall for latency depend on index statistics and hardware locality. Accordingly, the transformed format of embeddings and their retrieval from a vector database using RAG represent a computer-specific optimization that enables the disclosed information retrieval techniques to supply relevant context to ML models at speeds no manual process could achieve (e.g., within three seconds).

As described herein, “machine learning” refers to a class of computational techniques and models, including to neural networks, transformer-based architectures, generative artificial intelligence, decision trees, support vector machines, clustering algorithms, and statistical learning methods. These techniques and models enable a computer system to automatically learn patterns or representations from data and improve performance on a given task without being explicitly programmed with task-specific rules. ML systems may operate in supervised, unsupervised, semi-supervised, reinforcement, or self-supervised learning paradigms, and may be designed to perform a wide range of tasks such as classification, prediction, generation, translation, anomaly detection, and optimization across various data modalities, including text, images, audio, video, and structured data.

As described herein, a “model” refers to a computational system, algorithm, or structured representation used with a ML system. Examples of models include ML models, neural networks, transformer-based architectures, generative models, reasoning models, agentic systems, probabilistic models, statistical models, or rule-based systems. Models may be designed to process input data and produce outputs, predictions, decisions, actions, representations, or generated content. Models may operate under various learning paradigms, including supervised, unsupervised, semi-supervised, reinforcement, or self-supervised learning, and may be configured to perform tasks such as classification, regression, recommendation, anomaly detection, generation, translation, summarization, planning, decision-making, or multi-step reasoning across a range of data modalities, including structured data, text, images, audio, video, and sensor data.

As described herein, a “tool” refers to a discrete, callable unit of functionality that is registered within a platform registry and made accessible to one or more subsystems of an application. A tool may encapsulate a particular software capability, module, or feature, and may be invoked directly by a user or indirectly by an orchestration engine, assistant subsystem, or agentic process. A tool may be defined by a metadata specification that describes its functional purpose, input parameters, output types, and access constraints. Such metadata may further include contextual invocation rules or skill-gating requirements that limit tool execution based on user roles, system state, or external conditions. A tool may also be executed within the host application or may trigger remote services, APIs, or external modules. For example, a tool may perform data transformation, retrieve content from a content management system, initiate ML inference, or apply an automation feature to a digital asset. Tools may be atomic (e.g., performing a single function) or composite (e.g., orchestrating multiple underlying functions).

As described herein, a “module” generally refers to a discrete, encapsulated software unit that implements a defined subset of functionality within a larger system. For example, a module may include executable code, data structures, and associated interfaces that collectively enable the module to perform one or more tasks, operations, or services. In some implementations, a module may expose an API or inter-process communication interfaces through which other system components (e.g., agents, tools, or orchestration engines) may invoke module functionality. The module may be configured for local execution within an application runtime or for remote execution via a distributed service environment.

As described herein, a “collection” generally refers to a structured data container defined within a content management system. A collection may include one or more fields specifying attribute types and constraints, where each field is configured to store content of a designated type (e.g., text, image, reference, or relational identifier). The collection may further define a schema for a class of content items and may be programmatically bound to presentation templates for automatic instantiation of one or more web pages or components.

As described herein, a “component” generally refers to a reusable design element or grouping of design elements within a visual design environment. A component may include structural markup (e.g., containers, text elements, media placeholders), style definitions (e.g., Cascading Style Sheets (CSS) class associations), and behavioral attributes (e.g., event listeners, animations). Components may be instantiated multiple times across different pages, with instances linked to a common definition such that modifications to the component definition propagate to each instance.

As described herein, a “schema” generally refers to a structured definition that specifies the organization, attributes, and relationships of data within a system. A schema may define one or more fields, each field associated with a data type (e.g., text, integer, media, or relational reference), a set of constraints (e.g., required, optional, uniqueness), and optionally a linkage to other schemas or data sources. The schema operates as a blueprint governing how data is stored, validated, and retrieved by the system. A schema may be represented in a machine-readable format (e.g., JavaScript Object Notation (JSON), Extensible Markup Language (XML), proprietary markup), enabling programmatic generation of data containers and enforcement of structural consistency across instances. At runtime, the system may validate input data against the schema to ensure compliance and may utilize the schema to automatically bind data values to corresponding fields or locations of a webpage.

As used herein, a “template” generally refers to a parameterized layout structure defining a presentation format for one or more data-driven pages. A template includes a set of design elements, placeholders, and binding definitions linking fields of a collection to corresponding elements of the layout. Upon execution of a publishing or rendering process, the template is programmatically combined with data from one or more collection items to generate fully populated output pages or views.

As used herein, “interactions” generally refer to declarative animation and behavior specifications that define dynamic changes to one or more elements of a rendered page in response to runtime events. An interaction may include a trigger definition identifying the initiating event, a set of target elements, and one or more animation or state-change operations to be applied to the target elements according to defined timing or sequencing parameters.

As used herein, a “trigger” generally refers to an event condition that initiates execution of an associated interaction or workflow. Triggers may include user-interface events (e.g., click, hover, scroll, page load) or system-generated events (e.g., content update, data submission). A trigger definition may specify the scope of the monitored condition and, upon detection of such condition, causes initiation of the corresponding action sequence.

As used herein, “logic” refers to a declarative workflow specification defining automated operations to be executed in response to system or user events. Logic may be represented as a sequence of interconnected nodes or steps, where each step specifies an action (e.g., data manipulation, API request, content update) and may include conditional branching, variable mapping, or external service integration. Logic is evaluated and executed by a backend workflow engine in response to event detection.

As described herein, an “agent” (or “ML agent”) generally refers to a software entity configured to operate autonomously or semi-autonomously within a computing environment by perceiving context, evaluating state, and executing one or more actions on behalf of a user or system. Agents may incorporate ML models (LLMs, LAMs), or other ML-based subsystems that enable adaptive behavior, natural language processing, decision-making, and dynamic invocation of system functionality.

Further, an “agentic” process or behavior generally refers to the autonomous or context-driven execution of actions by an agent, without requiring explicit step-by-step instructions from a user. For example, agentic functionality may include interpreting natural language or multimodal prompts based on processing input queries submitted by a user. In other examples, agentic functionality includes determining relevant goals or sub-tasks, invoking software capabilities (e.g., tools, functions, external services registered) within a platform registry, and sequencing or chaining such invocations until an objective is satisfied.

As discussed in detail below, the ML techniques disclosed herein may be provided to augment, streamline, and/or improve various aspects of a web experience platform that allows users to perform various types of actions relating to website development (e.g., access, design, develop, build, access, manage, analyze). Through ML usage, the techniques disclosed herein may allow users to generate website or webpage content that conforms to structure and schema of a designated webpage. For example, in a ML-enabled web experience platform, when a user requests for changes or modification to components of a webpage, the ML models may be configured to create new text, images, and other relevant content based on the user text, prompt, selection, or other input provided by the client device.

Implementations of the present disclosure are described in further detail herein with reference to the creation of content for webpages. In some implementations, the techniques described in this present disclosure are applicable to the creation of content for other applications, such as applications, emails, product designs, brochures, or other products, to name some examples.

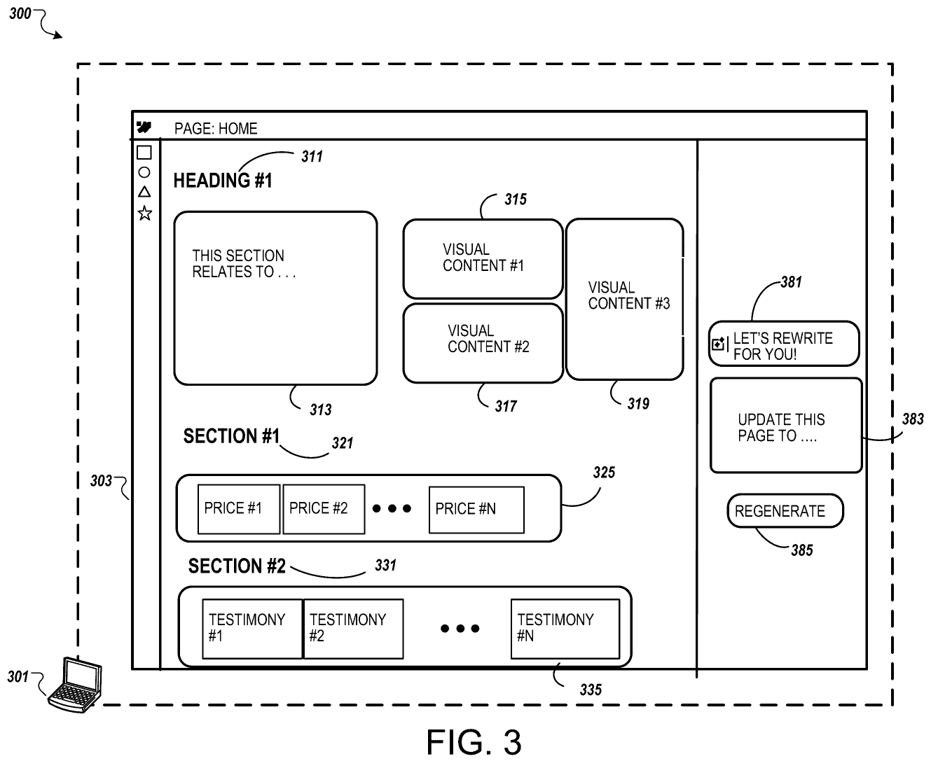

FIG. 1 illustrates an example of a technique for generating content for webpage components in a webpage in response to a user request according to semantic similarity using one or more ML models and a content management system 120. In the example shown, the controller device 102 may display a home page, a starting page, or an application 152A for a controller or a user of the controller device 102. Application 152A includes a user interface 154 (e.g., a text-based chat interface) that enables the user to input requirements for generating content for webpage components of a website or a webpage in the input box 156. In some implementations, the user interface 154 may also provide brief guidance on how to input a request for generating content for webpage components based on the semantic hierarchy of those components. This architecture enables application 152A to capture user requirements for content generation according to the semantic hierarchy through an open-ended, chatbot-like interface. More details of the user interface 154 are described below in connection with FIG. 3.

The CMS 120 generally may identify the semantic hierarchy 116 based on the user request and optional context information, with more details described immediately below. In some implementations, the system may enable the user to specify the semantic hierarchy through the user interface 154 or the input box 156, rather than having the CMS 120 identify the semantic hierarchy 116. For example, the user may specify a semantic hierarchy for one or more webpage components in the input box 156, for which the user plans to generate content using the described system. This way, the system enables the user to specify hierarchy based on their preference and may override the hierarchy information stored in CMS 120. As shown in FIG. 1, the controller device 102 and the application 152A interact with the server(s) 110 to generate content for webpage components. This may be accomplished according to the requirement data specified by the user (e.g., user input text, user selection) and/or based on the semantic hierarchy (which specifies the structure of webpage components).

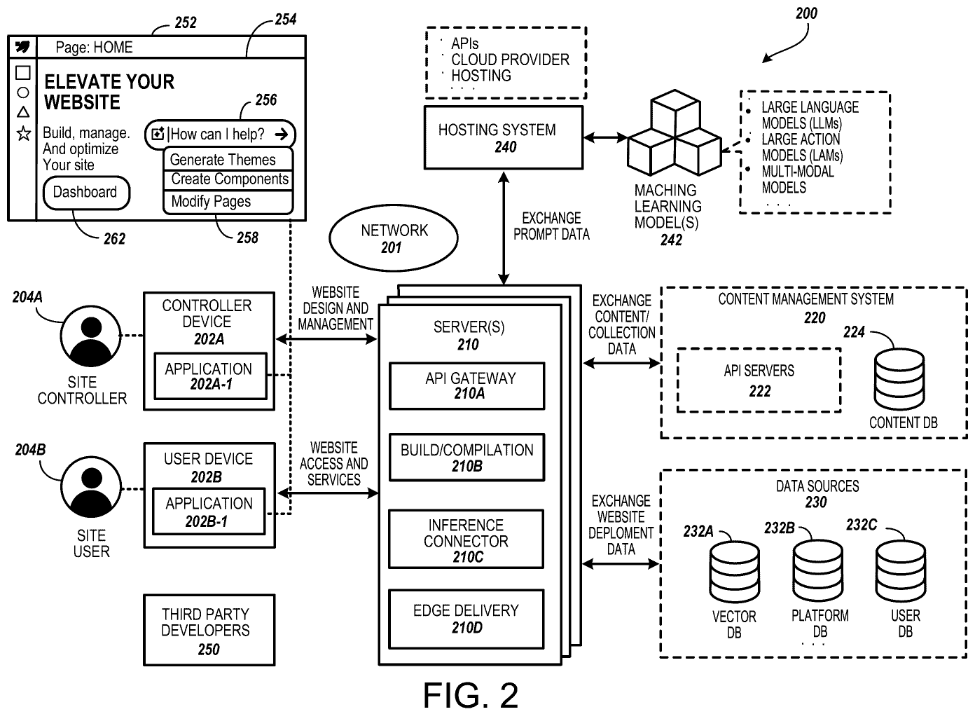

More specifically, in addition to the controller device 102, the system or platform described herein (e.g., the WEP shown in FIG. 2) includes one or more server(s) 110, a CMS 120, data sources 130, and a hosting system 140. The hosting system 140 is further communicatively coupled with one or more ML models, deployed on or remote to the hosting system 140. These elements implement backend processes (e.g., information retrieval, information refinement, prompt generation/submission, output processing, output refinement) relating to user actions on a software frontend and information presented responsive to these user actions.

For example, a user may initiate a request to generate content for one or more webpage components within a webpage through the user interface application 152A. In response, a series of backend processes executed by the server(s) 110, the CMS 120, the data sources 130, and the hosting system 140 collaboratively facilitate the content generation workflow corresponding to the user's request. In some implementations, CMS 120 identifies a semantic hierarchy 116 based on the user request data 104. In other implementations, the user may explicitly define or influence the semantic hierarchy by assigning hierarchical orders to different webpage components through the user interface application 152A.

The server(s) 110 may further receive context data 106 from the controller device 102 to assist in identifying or refining the semantic hierarchy associated with the requested webpage components. The context data may include workspace context, section metadata, user-specific historical data, or other relevant contextual information as previously described. Using this information, the system generates prompt data for one or more ML models based on the identified semantic hierarchy, which may be obtained either from the CMS 120 or directly from the user request data 104.

By grounding the prompt data in semantic hierarchy information and associated context data, the system ensures that the output generated by the ML models reflects the intended structure, abstraction level, and relationships among the webpage components. As a result, the generated content remains semantically coherent and contextually aligned with both the user's request and the design architecture of the webpage.

Referring back to FIG. 1, after the user finishes entering the requirements for content generation into the input box 156 or other interfaces represented on application 152A, the user may interact with one or more UI elements to transmit the requirement data to the server(s) 110. This may be done, for instance, by clicking a push button (not shown) or by pressing the “Enter” key on a keyboard. The system then processes the request for content generation in the backend, which may take from several seconds to a few minutes, and subsequently displays a next representation 152B of the application 152A, with generated content populated in corresponding webpage components for the user's review, modification, and/or confirmation.

More specifically, the next representation 152B may display one or more candidate, semantically coherent content items generated by backend processes in accordance with the semantic hierarchy specified by (or derived from) user request data. As shown in FIG. 1, the next representation 152B may include multiple webpage components corresponding to different hierarchical levels of the webpage.

In some implementations, the next representation 152B may include a first webpage component 162 that presents several candidate content items generated for one or more sections of the webpage. A user operating the controller device 102 may select one or more of these candidate items to populate the corresponding sections. For instance, the sections may represent high-level topics or feature categories of the webpage, and the generated content items may include descriptive overviews, summaries, introductory statements, pricing list(s), or other suitable content associated with those sections.

As another example, the next representation 152B may include a second webpage component 164 that presents candidate content items corresponding to one or more headings.

The user may select one or more of the heading candidates for placement within their respective section hierarchy. In this example, the headings may define subtopics, technical features, or thematic groupings within the broader section content, and the generated content items may include concise phrases, taglines, sub-headers, or other suitable content reflecting the contextual relationship specified in the semantic hierarchy.

Yet as another example, the next representation 152B may include a third webpage component 166 representing candidate content items generated for one or more text bodies associated with the selected headings. The user may choose one or more of these candidates to populate the corresponding text body fields. In this example, the text bodies may include paragraphs elaborating on respective aspects of the associated headings (e.g., detailed descriptions, feature explanations, narrative content supporting the overarching section theme).

The representation 152B may also include multiple user-interactive elements that enable the user to modify, refine, or customize the generated content. For instance, the user may select a candidate content item for a particular webpage component from a set of options provided by the server(s) 110, adjust specific portions or the entirety of the content through corresponding user interface controls, or select or deselect generated content items using dropdown menus or other selection tools. Additionally, the user may input textual or audio instructions to remove, replace, or edit textual or visual content generated by the ML models and/or retrieved from the CMS 120. More specifically, the next representation 152B may include a user action section 172 for collecting additional user inputs. For instance, the user may select one or more actions from a dropdown menu 174 within the user action section 172. These actions may include selecting, deselecting, updating, or regenerating textual or visual content using ML models. More details of the next representation 152B are described below in connection with FIG. 3.

Referring back to the backend process, after the user completes entering the user requirement data for generating content for one or more webpage components, the controller device 102 transmits the request data 104 to the server(s) 110 for downstream processing. The request data 104 may include text-based user requirements entered through the input box 166, such as style preferences, tone specifications, target audiences, or topics associated with respective webpage components. In some implementations, the request data 104 may identify one or more webpage components targeted for content generation through user interactions with the webpage authoring application 152A, text-based inputs entered in the input box 166, or other suitable interaction mechanisms. In some implementations, the user request data 104 may also define or reference a semantic hierarchy associated with the selected webpage components, as specified by the user through suitable interactions with the controller device 102.

In some implementations, the controller device 102 may further transmit context data 106 to the server(s) 110 to assist in refining or constraining the content generation process. The context data 106 may include workspace context, section metadata, user-specific historical data, or other relevant contextual information as previously described. More specifically, the workspace context may include information describing the user's active workspace, such as the currently selected page, active user interface elements, component hierarchy, or recent authoring actions. The user-specific historical data may include behavioral or preference information inferred from prior webpage generation activities, as well as user profile data maintained in a distributed multi-tenant database. The section metadata generally relates to structured information that describes individual sections or subsections of a webpage, and optionally, the hierarchical relationships between them. The section metadata may include identifiers, content type definitions, associated layout templates, and semantic tags that indicate each section's position within the overall hierarchy. For example, section metadata may define that a “Product Overview” section precedes a “Technical Details” section and inherits its tone and styling rules from a higher-level landing page.

Upon receiving the request data 104 (and, optionally, the context data 106), the server(s) 110 may identify, based on the request data 104, a semantic hierarchy 116 specified within the CMS 120 for one or more webpage components. To identify the semantic hierarchy 116, the server(s) 110 may determine a measure of semantic similarity between the request data 104 and respective content data stored in the CMS 120 or data resources 130. The system then determines the semantic hierarchy 116 for the request data 104 based on the semantic hierarchy associated with stored content data having a semantic similarity score above a predefined threshold. For example, if the request data 104 includes a user prompt such as “generate a technical overview section,” the system may identify existing content in the CMS 120 tagged as “overview” or “summary-level” content with high semantic similarity. CMS 120 may associate such content with a first-tier hierarchy level corresponding to abstract, high-level text. Based on this match, the system may infer that the user's requested section should inherit the same hierarchical level. Conversely, if the request data 104 references a “product specification” or “API description,” the system may match it to lower-tier, more detailed content and assign an appropriate hierarchical level characterized by higher complexity and specificity.

In some implementations, the server(s) 110 may further process the context data 106 in a vector feature space and fuse the resulting vector features of the context data 106 with the vector features of the request data 104 to generate fused vector features. The fused vector features may then be used to identify the semantic hierarchy 116 using the semantic similarity approach, as described above. The fusion process allows contextual information to refine or disambiguate the hierarchical level of the requested content.

In certain implementations, the user may explicitly specify the semantic hierarchy within the request data 104. In these scenarios, the server(s) 110 may directly obtain the semantic hierarchy 116 from the CMS 120 without performing similarity computations between the request data 104 and existing CMS content. Alternatively, when the request data 104 already includes detailed hierarchical information for the webpage components, the server(s) 110 may not need to retrieve the semantic hierarchy 116 from the CMS 120 or data sources 130 at all. Instead, the system may rely entirely on the user-specified hierarchy to guide subsequent prompt generation and content synthesis operations.

The server(s) 110 may generate prompt data 112 based on the request data 104 and the identified semantic hierarchy 116 (and, optionally, the context data 106). Prompt data 112 serves as a structured set of machine-readable instructions used by the hosting system 140 for downstream execution. In some implementations, prompt data 112 may define the target content type, tone, style, complexity, and contextual grounding for each webpage component, according to the semantic hierarchy 116. The hosting system 140 receives the prompt data 112 and executes one or more ML models 142 to generate raw output data 114. This raw output data 114 may include various types of content data.

More specifically, the output data generated from the ML models may include content with various levels of complexity, such as high-level narrative content (e.g., summaries, statements, taglines), mid-level explanatory content (e.g., product description, feature explanations, case studies), and low-level detailed content (e.g., technical specifications, configuration instructions, FAQs, pricing tables).

The output data from the ML models may include content with various linguistic features. For example, the output data may have various tones, e.g., a formal tone for legal, corporate, or academic webpage components, an informative tone for technical or education webpage components, a conversational tone for consumer-facing webpage components, or other suitable tones. The output data may also vary in style. For example, the content may exhibit a persuasive style for marketing components, an objective style for educational or informational components, a descriptive or narrative style for storytelling or brand histories.

The output data may include various formats or types. For example, the output data may include visual content such as images, videos, text, or other suitable visual content. The output data may include audio content, such as recordings, music, or other suitable audio content. The output data may further include interactive or responsive content (e.g., prompts, links, customized recommendations).

The raw output data 114 is then returned to the server(s) 110 for further post-processing. During post-processing, the server(s) 110 fuse the raw output data 114 into the corresponding locations of the webpage components of a website or webpage to generate one or more candidate webpages. The fused results are converted into processed output data 108, a representation that is optimized for rendering on the controller device 102. The processed output data 108 includes both the content and the structural instructions necessary to display the candidate webpages with generated content within the next representation 152B of application 152A. Once received and executed by the controller device 102, the processed output data 108 causes the controller device to render the candidate webpages for user interactions (e.g., selecting, modifying, or regenerating webpage content), thereby enabling iterative refinement of the generated webpages as described above.

The information retrieval techniques shown in FIG. 1 improve upon RAG-based pipelines involving static vector databases. ML systems that rely on such RAG-based pipelines typically embed free form documents without regard to application schemas. Similarly, some CMS platforms typically store typed records without generating embeddings that preserve referential constraints or field semantics. In contrast, the techniques shown in FIG. 1 involve generating schema-aware content chunks and corresponding vector representations that explicitly preserve CMS configurations and limitations. Chunk boundaries and embedding metadata are aligned to collection schemas, field types, and cross-reference links (e.g., component IDs, locale variants, or gated fields) so that retrieved content may be injected into prompts and rendered back into the authoring environment without violating referential integrity.

The schema alignment discussed above improves performance in two ways. For instance, it increases retrieval precision by ensuring preference over chunks whose schema tags match the workspace context of application 152A. Further, it reduces post-retrieval repair work because the output data from the ML models 142 is constrained to data models specified by the CMS 120. This is distinct from implementing a standard RAG index with a CMS, which does not involve specific types of chunking and embedding that preserve field-level typing, relationship graphs, and policy constraints.

Moreover, RAG pipelines also tend to produce static indexes (e.g., embeddings computed once and reused until a full rebuild). Similarly, CMS platforms update content continuously without coordinating vector freshness. The system and techniques described within this disclosure address this capacity gap with a recursive, CMS-driven update loop that re-embeds only the affected chunks when schemas, features, or referenced records change, and advances version pointers so retrieval prefers up-to-date vectors.

In some implementations, CMS events (e.g., content publish, schema edit, feature flag change) trigger dependency resolution that identifies impacted chunks, recalculates embeddings, and atomically swaps index entries so the vector database reflects the current configuration without a global reindex. This architecture addresses a known limitation of static RAG, which answers that are accurate to their source but outdated or misaligned to a user's current configuration. As shown in FIG. 1, by ensuring that similarity searches are performed over a living corpus whose semantics align with the CMS 120, the resulting benefits include improved contextual relevance and enhanced responsiveness.

The interplay between schema-aware embeddings and the recursive CMS updates also yield various advantages at runtime. For instance, because vectors carry schema and version tags, the server(s) 110 may condition query refinement on the workspace context and select only those chunks whose schema/version signatures match the user's workspace context. This reduces false positives that some RAG systems would surface. Conversely, as the CMS 120 evolves (e.g., a component API changes), update loops ensure the same signatures steer retrieval away from superseded guidance without requiring manual curation. This closed-loop behavior informs how the server(s) 110 orchestrates retrieval and prompting under latency constraints and at multi-tenant scale. This behavior also depends on specific types of data transformations and index maintenance strategies that are specific to typed, evolving application schemas and their operational event streams.

FIG. 2 illustrates an example of a system 200 enabling a web experience platform (WEP) for enabling website development using one or more ML models. In general, the website development capabilities enable users to design digital experiences, ingest user-defined digital experience specifications, transform the user-defined digital experience specifications into deployable artifacts, and distribute resulting web experiences over a network. For example, the WEP may receive design-time input that specifies pages, components, styles, interactions, and content, compile or otherwise process that input (e.g., assistance from one or more ML models) into executable markup, code bundles, media, and metadata. The WEP may store intermediate and final artifacts in multi-tenant data stores, identify published experience and associated application services to site visitors with edge-based delivery resources. This environment may further support content management, e-commerce, membership gating, localization, extension APIs, among other types of functionality.

In general, system 200 leverages ML within a content-management, schema-constrained WEP to address computer-centric problems in generating, selecting, and rendering webpage modifications at scale. System 200 obtains structured inputs defined by a content schema and associated metadata (e.g., section-level or hierarchy information), constructs constrained prompt data or model inputs from those structures, and applies trained ML models to produce candidate outputs that are validated for structural compatibility before use in the build and delivery pipeline. By grounding ML operations in machine-readable constraints and executing only schema-compatible results, system 200 improves computer operation in distributed web systems (e.g., by reducing integration failures, avoiding incompatible markup, limiting unnecessary network transfers, and enabling low-latency rendering of a single, selected variant on the client device). The WEP further augments and/or improves various aspects of the web development functionality through use of one or more ML models 242. These ML models 242 may be invoked at multiple, independent junctures of WEP workflows to streamline, accelerate, and/or augment tasks that have traditionally needed manual development effort.

For example, a site controller operating the controller device 202A may access an ML interface 256 (e.g., presented as a text-chat, voice, or multimodal panel within the existing design canvas) to submit natural language prompts that cause the one or more ML models 242 to generate entire page layouts, reusable components, helper functions, and the corresponding markup or code artifacts without leaving an authoring environment. After a site has been deployed, other ML interfaces may be used to request automated regeneration or modification of components in a manner that preserves data bindings and collection schemas maintained by a content management system (CMS) 220. This reduces the risk of breaking existing CMS-driven pages.

In another example, a site controller 204A or site user 204B administrator may invoke an ML assistant exposed through a dashboard widget to obtain step-by-step guidance on operational tasks (e.g., configuring localization variants, setting up gated-membership rules, or troubleshooting performance settings) based on conversational queries rather than navigating multiple configuration panels. Each of these interfaces may simply route prompt data to external model resources (e.g., hosting system 240) and returns model output to the same front-end context, the ML functionality may be layered onto different phases of the website-development lifecycle without requiring structural changes to the underlying build, orchestration, or delivery services.

The WEP includes various computing and data elements, examples of which are shown in FIG. 2. These elements generally exchange data over network 201. Controller device 202A represents an authoring endpoint operated by a site controller. User device 202B represents a consumption endpoint operated by a site user. Additional third-party developer devices 250 may interact with extension tooling.

One or more server(s) 210 enable centralized functionality associated with the WEP. These server(s) 210 may correspond to the server 122 shown in FIG. 1. As such, server 122 may perform the functionality described with respect to server(s) 210. Server(s) 210 further include API gateways 210A, orchestration modules 210B, build/compilation modules 210C, inference connector modules 210D, and edge-delivery modules 210E, each of which cooperate to perform request handling, background workflow, artifact generation, machine-learning integration, and content delivery network (CDN)-style dissemination, respectively. CMS 220 encloses API servers 230 and a content database 212B. Further, data sources 230 includes persistent stores, such as vector database 232A, platform database 232B, user DB 232C. A hosting system 240 exchanges prompt data and model output with one or more ML models 242.

In more detail, the site controller 204A may operate a controller device 202A (e.g., desktop computer, laptop, tablet, or similarly capable computing terminal). The controller device 202A executes an authoring application 202A-1 that communicates with WEP over network 201. Using the authoring application 202A-1, the site controller may generate, import, or modify design-time assets (e.g., page structures, component libraries, style sheets, interaction timelines, and data bindings) and submit corresponding save, build, or publish requests to server(s) 210. Controller device 202A may render the authoring application in a browser context, a native container, or another runtime environment, and may exchange design-and-or-maintain website-deployment data with the platform in real time or near-real time.

A site user 204B may operate a user device 202B (e.g., desktop computer, laptop, tablet, smartphone, set-top box) executing a runtime application 202B-1 that requests and renders published site assets delivered by server(s) 210. The user device 202B may load static pages, dynamic CMS-backed content, e-commerce flows, membership-gated resources, or localized variants, depending on how the site was configured by the controller. Interactions initiated from the user device 202B may result in access-and-or-interact website-deployment data being exchanged with server(s) 210, with optional personalization, authentication, or analytics processing performed along the way.

As shown in FIG. 2, the authoring application 202A-1 presents a designer interface 252 that provides access to visual tools enabling a site controller 204A to construct and/or alter a page 254 without direct manipulation of source code. Within interface 252 a component pane may surface reusable elements such as component 262, and a canvas or viewport may preview the evolving layout in real time. An ML interface 256 permits the site controller 204A to issue natural language prompts or other inputs to interact with one or more ML models 242 via the hosting system 240. Interface 256 may be implemented in various ways, such as a chat panel, voice overlay, multimodal widget, among others. Responsive model output may drive ML-assisted functions 258, which may include, for example, automatically generating page sections, refactoring existing component 262 for accessibility or localization, producing CMS-compatible schema suggestions, or inserting client-side logic templates. Depending on configuration, similar ML interfaces may also surface within runtime application 202B-1, allowing site users to obtain guided assistance or perform management tasks through conversational interaction.

Server(s) 210 operate as the execution core of WEP, receiving network traffic from external actor devices, coordinating internal workflows, invoking machine-learning resources, and emitting deployable or runtime assets. Although depicted as a single logical block, server(s) 210 may be implemented as a co-located cluster, a distributed micro-service mesh, or a cloud-hosted arrangement that scales elastically with demand.

Further, server(s) 210 incorporate a set of software modules configured to cooperate through message queues, RPC calls, or other service-bus mechanisms. At a high-level API gateway modules 210A handle synchronous ingress. An orchestration tier (not shown in FIG. 2) manages background or long-running tasks. Build/compilation modules 210B convert design input into deployable artifacts. An inference connector layer 210C broker prompt exchange with the hosting system 240. Edge delivery modules 210D stage static and dynamic resources for low-latency distribution. Each module may be containerized, serverless, or otherwise independently deployable, allowing updates to be rolled out without interrupting the WEP.

API gateway modules 210A perform various functions, such as terminating Transport Layer Security (TLS), validating JavaScript Object Notation (JSON) Web Tokens, and expose Representative State Transfer (REST), Graphical Query Language (GraphQL), or WebSocket interfaces that client applications call when saving designs, fetching CMS content, or running administrative queries. They may apply per-workspace or per-site rate limits, translate external resource identifiers into internal shard keys, and inject correlation metadata into each request for downstream tracing. In zero-trust configurations, the API gateway modules 210A may also perform mutual-TLS handshakes with edge nodes or developer command line interfaces (CLIs) before forwarding traffic onto the internal mesh.

Build/compilation modules 210B retrieve development snapshots, CMS bindings, and theme settings, then emit hashed asset bundles, pre-optimized image variants, framework-specific component libraries, and search-index manifests. A dependency graph may be used to identify pages or assets that are invalidated by a change so that a full rebuild is avoided. Unchanged artifacts may also be linked from previous build versions. Output objects are written to a versioned S3-style bucket, tagged with a content hash and build-number metadata, and handed off to edge-delivery modules for global propagation.

Inference connector modules 210C assemble prompt payloads that may include design fragments, content snippets, schema fingerprints, and user-authored questions. The inference connector modules 210C may sign each request with a per-workspace API key, apply temperature or max-token policies set by workspace administrators, and/or dispatch prompts to an external model endpoint over authenticated (e.g., HTTP/2) channels. Inference connector modules 210C also parse received model output into typed actions, such as “generate component,” “rewrite copy,” or “suggest accessibility fix.” These parsed outputs may be queued back to orchestration modules or streamed directly to user devices.

Edge delivery modules 210D take artifacts produced by the build/compilation modules 210B and replicate them across geographically distributed points of presence. Assets may be version-pinned so a canary rollout may serve the new build to a percentage of traffic while the prior build remains active for the remainder. Edge workers may also execute JavaScript or WebAssembly to perform request-time tasks (e.g., cookie-based A/B routing, on-the-fly image resizing, server-side rendering of personalized fragments) before returning a response that is cached for subsequent requests.

The architecture of server(s) 210 enable various applications of ML models 242 in relation to different web development workflows accessible through the WEP. In some implementations, server(s) 210 enable an authoring workflow in which a newly added component is propagated from the design canvas to production in near real-time. For example, when a controller drags a “testimonial” component onto the canvas, the interface 252 emits a JSON delta via WebSocket to API-gateway modules 210A. Orchestration modules enqueue a build job, and the build/compilation modules 210B regenerate only the affected page bundle while reusing shared CSS and runtime libraries. Inference connector modules 210C send the component copy to ML models 242 (e.g., LLM) and requests tone-consistent rewrites. Model output data is then streamed back to the interface 252 for user review and approval. The edge delivery modules 210D pre-warm caches for the updated path, enabling publishing to be completed quickly (e.g., under a second).

In some implementations, server(s) 210 enable a live component-refactor workflow that automates accessibility or structural updates across an existing site. A site controller 204A may type “convert nav bars to an accessible drop-down” into ML interface 256. In response, inference connector modules 210C package a prompt containing the site's navigation markup and audit results, retrieve refactored HTML, and forward the patch to build-and-compilation modules 210B. After incremental compilation, edge-delivery modules 210D push the new build while invalidating only nav-bar assets. A rollback pointer to the previous build is retained for instant reversion if post-publish tests fail.

In some implementations, server(s) 210 enable an administrative guidance workflow that delivers conversational, ML-generated instructions for platform configuration tasks. For example, a site user 204B may interact with a voice widget to ask, “How do I enable multi-language support?” In this example, a voice clip may be transcribed on the user device 202B and posted to API-gateway modules 210A. Inference connector modules 210C query one or more ML models 242 (e.g., knowledge base aware model) that returns a checklist of localization steps plus one-click mutation calls. Orchestration modules then create a location workspace, build/compilation modules 210B obtain locale variants, and edge delivery modules 210D begin serving Accept-Language aware routes. This workflow allows the task to be completed without manual navigation through multiple settings screens.

CMS 120 manages structured content that populates pages, components, and dynamic lists served by WEP. The system lets a site controller define collections, fields, and localized variants, then stores and surfaces that content so that build and runtime processes may merge it with design artifacts. During ML workflows prompts may be enriched with relevant collection entries or schema information. Model output may be validated against the same schema to ensure that any generated markup stays coordinated with stored data.

CMS 220 further includes API servers 222 and content database 224. The API servers 222 expose read and write endpoints that the design canvas, build pipeline, and runtime site all consume. The content database 224 stores collection items, draft, locale variants, and reference links (e.g., in a multi-tenant partition so that different workspaces remain isolated). These elements of CMS 220 let other modules in WEP (e.g., modules of server(s) 210) treat content as a typed data source rather than raw text.

API servers 222 may implement REST and GraphQL methods for creating collections, uploading media, managing localization, and querying entries at build or request time. Requests enter through API gateway modules 210A and are routed to the appropriate microservice shard. Each call is checked against workspace roles so that only authorized users or processes may insert or mutate content. Server(s) 210 also transmit events that orchestration modules may listen to trigger incremental rebuilds or cache purges.

Content database 224 is a multi-region document store that persists collection schemas, field values, slug indexes, and locale mappings. Each write operation may be versioned, allowing rollback if a site controller 204A accidentally deletes or changes an entry. The content database 224 supports full-text and faceted search so that runtime pages may query on reference fields without loading entire collections. It also stores media metadata that edge delivery modules 210D may use for responsive image selection.

Interaction between API servers 222 and content database 224 may follow a strict commit path. For example, API servers 222 validate incoming payloads against collection schemas, transform the payloads into storage records, and write them to content database 224 in a transaction that ensures referential integrity. When data changes the servers publish a change event to orchestration modules. Build/compilation modules 210B may pull the updated entries, regenerate only the affected pages, and write new artifacts to the build repository. Edge delivery modules 210D receive a signed cache bust instruction so that users see the updated content without delay. This communication loop ensures design, content, and deployment states are aligned even when ML models generate or modify content through the same APIs.

Data sources 230 provide a storage layer that underpins content retrieval, ML context, and runtime personalization for WEP. Databases included in the database sources 230 may sit outside the server(s) 210 so it may scale storage capacity independently of compute demand. For example, read and write operations flow through API gateway 210A or orchestration tasks, and change events propagate to build or edge services so that newly stored records appear in published sites without manual intervention. During prompt generation, the inference connector 210C enriches requests with context fetched from these stores, and after model inference, the same stores are updated or queried to confirm that generated output aligns with existing schemas.

Vector database 232A stores high-dimensional embeddings that represent component code snippets, CMS entries, design tokens, and knowledge base documents. The vector database 232A supports approximate nearest-neighbor search so the inference connector may retrieve semantically similar records in milliseconds. Embeddings are regenerated during build or on demand when a large batch of content changes. The store also tracks embedding versions so model prompts always receive context that matches the active design or content revision.

Platform database 232B holds project metadata such as workspace settings, build history, billing status, feature flags, and role assignments. Each workspace or site occupies a logical partition that isolates records while still allowing cross-workspace queries for administrative analytics. The database maintains foreign keys to build artifacts in object storage and to content items in CMS 220, which lets server modules assemble a complete view of a project without performing fan-out requests.

User database 232C records site member accounts, authentication tokens, membership tiers, and e-commerce order history. Access tokens generated by API gateway 210A map to rows in this store, allowing edge delivery modules 210D to evaluate gating rules during request processing. The user database 232C also captures engagement metrics such as last login time or page view counts, which may feed personalization or analytics dashboards.

The databases discussed above operate together through shared identifiers and event streams to maintain consistency across the platform. When a controller publishes a new collection item the CMS writes the entry to content database 224 and emits an event that triggers embedding generation in vector database 232A. The same event updates index pointers in platform database 232B so build modules may link the updated content to its deployment record. If the item is member-restricted, a policy pointer is stored in user database 232C so edge delivery modules may enforce access at request time. This coordinated flow ensures that ML prompts receive up-to-date context, model output respects schema constraints, and published pages honor all access and personalization rules.

Hosting system 240 provides a managed inference service that receives prompt data from server modules and returns machine generated output used to augment website design, build, and runtime tasks. The hosting system 240 may allocate compute resources, schedule model workloads, enforce request quotas, and logs usage metrics. Prompt requests may include design fragments, CMS records, or visitor questions. Response payloads may contain generated code snippets, rewritten copy, layout suggestions, or operational guidance that the platform may apply without manual intervention.

Hosting system 240 integrates with the WEP through a set of network accessible endpoints that may be reached by direct API calls, by cloud provider private links, or by a customer managed hosting arrangement. The inference connector 210C authenticates each request with an API key, signs payloads, and posts them to an endpoint path that selects a specific model or model version. The hosting system 240 may reside in a public cloud region, in a dedicated tenancy, or in an on-premise cluster that meets data residency requirements. Configuration flags allow workspace administrators to choose among these connectivity modes without changing application code.

ML models 242 implement the inference logic that generates the information used by the WEP. The models may be large language models (LLMs) that excel at natural language generation, large action models (LAMs) that plan multi step tasks, or multimodal (MM) models that accept and emit combinations of text, code, or image embeddings. Each model may be versioned and measured for token usage, latency, and accuracy. The hosting system 240 may route traffic to a single model or to an ensemble of models depending on the prompt type and workspace policy.

ML models 242 operate inside the hosting system 240 in containerized runtimes, e.g., runtimes that that expose uniform gRPC and REST interfaces. The hosting layer may handle model loading, weights decryption, warm-up sequences, and autoscaling. It also injects guardrail middleware that checks prompts for policy compliance and truncates or redacts disallowed content. Model output is streamed back to system 200 in an event format that preserves token order so the authoring canvas may display partial completions in real time.

As discussed above, system 200 may be designed in various implementations to augment, improve, or streamline various aspects of website development using interactions with the one or more ML models 242. For example, a site controller 204A may access interface 252 on controller device 202A and enter a natural language prompt into ML interface 256 asking the platform to “generate a five-page marketing site for a coffee brand with warm colors and bold headings. ” Application 202A-1 then sends the prompt to API gateway modules 210A over network 201. Inference connector modules 210C forward the prompt to hosting system 240 which relays it to ML models 242. The ML models 242 return structured markup and component definitions that reference images and copy aligned with the request. Build/compilation modules 210B merge the generated markup with schema information pulled from content database 224 through API servers 222 so that every collection reference is valid. Edge delivery modules 210D publish the new artifacts and invalidate only the changed routes which lets user devices 202B immediately load the freshly created pages.

As another example, a site controller 204A may decide to localize the site for Spanish speaking visitors using the same workflow. The site controller 204A issues a prompt in interface 256 that requests translated versions of each collection item stored in content management system 220. API gateway modules 210A receive the prompt along with collection identifiers. Inference connector modules 210C assemble context by fetching the English records and related embeddings from vector database 232A then pass that context to ML models 242. The ML models 242 return translated field values which API servers 222 write as new locale variants in content database 224 while platform database 232B records a build dependency for each updated item. Build/compilation modules 210B regenerate only the localized bundles and edge delivery modules 210D tag them with Accept-Language rules so site users automatically receive the correct language version.

In yet another example, during ongoing operation a site user 204B signs in through application 202B-1 and asks an on-page chatbot how to schedule a product launch for next Friday. The question travels through network 201 to API gateway modules 210A and is passed to inference connector modules 210C with user context from user database 232C. ML models 242 analyze the prompt and return a step list that includes creating a draft collection item, assigning a release date, and triggering a publish event. The response also contains signed mutation requests that API servers 222 may execute on behalf of the authenticated user. Orchestration logic writes the new item to content database 224, schedules a timed build in platform database 232B, and notifies build and compilation modules 210B to pre render the page. Edge delivery modules 210D queue a cache purge for the launch path so the updated content appears exactly when the scheduled date arrives.

In some implementations, system 200 is configured to generate adaptive themes that evolve over time based on user behavior and preferences. For example, system 200 may utilize ML models 242 to provide continuous adaptation, which may ensure the long-term relevance and personalization of website themes. In some aspects, the ML models 242 for generating adaptive themes may include user inputs, presets or packs, prebuilt webpage sections, and prompts provided to a machine learning model. System 200 may also be configured to evolve at multiple levels to improve its theme generation capabilities.

For example, the evolution of presets may be based on updated industry trends, the evolution of prompts may be based on user behavior and preferences, or the evolution of an ML model itself may be based on making adjustments to achieve a desired performance. As another example, the evolution of prebuilt webpage sections may be based on adding new sections developed from industry trends or in response to user feedback. In some implementations, system 200 may employ a federated learning approach to improve its theme generation capabilities by learning from multiple users while maintaining individual user privacy. System 200 may also generate a continuously evolving and personalized website theme by adapting to user behavior, user feedback, and industry trends, all without the user having to manually update design elements to maintain relevance.

In some implementations, system 200 may generate a webpage design in response to one or more inputs provided by a user. For example, the site controller 204A may interact with the controller device 202A to provide an input, such as an image pack or a visual mood board. The controller device 202A may provide the input by selecting from one or more options presented within the designer interface 252. System 200 may then determine a theme from the provided input content and provide the determined theme to the one or more models 242.

The one or more ML models 242 may then provide a page, or a portion of a page design, as output. System 200 may further allow site controller 204A to review this output and prompt the one or more ML models 242 to iterate on the design, for example, by providing additional input or feedback on the generated page or portion. Accordingly, once the user is satisfied with the generated design, system 200 may provide the page or portion of the page to another system, such as a web development platform, for the webpage or website to be built, without the user having to manually create design specifications or write code, and preserving a feedback-driven workflow.

As described throughout, system 200 may provide a comprehensive ML-driven system for creating, managing, and evolving a complete design system for a website. System 200 may analyze user inputs, brand guidelines, and industry trends to establish core design principles for a website. System 200 may then generate a full design system that may include, for example, a typography hierarchy, color palettes, spacing and layout rules, component libraries, and responsive design guidelines, among others. In some aspects, user inputs and brand guidelines may be received through step-by-step intake forms. In other aspects, system 200 may provide presets or packs, such as prebuilt webpage sections, that are built based on influences from industry trends for a user to select. System 200 may generate a complete and coherent design system based on high-level user inputs, without the user having to manually define each design rule or create a component library from scratch, thereby streamlining the brand identity creation process.

In some implementations, system 200 may include one or more key features to perform specific web development tasks. For example, system 200 may utilize a generative adversarial network (GAN)-based module to generate unique visual assets. The visual assets may include, for example, on-brand icons, illustrations, or patterns. As another example, system 200 may provide an ML-style transfer engine that automatically adjusts images to fit the established design system. System 200 may additionally provide an ML-powered design consistency checker to assist in ongoing website maintenance by identifying and flagging inconsistencies. In some implementations, a user may interact with these features through a natural language interface, which allows non-designers to make informed design adjustments. System 200 may thereby make design generation and maintenance capabilities accessible to a wider range of users, without requiring the user to have specialized design skills or perform manual consistency checks.

In some implementations, system 200 provides an ML-based design consistency checker using the one or more ML models 242 to analyze design elements across a generated website. For example, a user may desire to check for design consistency as a web development task. In this example, the ML-based design consistency checker is configured to identify inconsistencies in design elements. The design elements may include, for example, color, typography, spacing, or other design aspects, among others. Upon identifying an inconsistency, system 200 may flag the potential issue and suggest one or more corrections to the user. In this way, system 200 assists in maintaining a cohesive visual identity over time, without the user having to manually inspect webpages for design deviations or possess expert knowledge of the established brand guidelines, thereby preserving the integrity of the design system.

In some implementations, system 200 provides frameworks that ensure consistency, scalability, and brand alignment through continuous evolution of a design system. For example, a user may request to have the design system updated as a web development task. In this example, the design system may evolve based on various data inputs, including user interactions, A/B testing results, and emerging design trends, among others. As another example, design system evolution may further be based on other types of updates (e.g., user inputs, presets/packs, prebuilt webpage sections, ML prompts, ML model updates). In this example, system 200 maintains a relevant and effective design system over time, without requiring a user to manually track and implement changes based on performance data or industry trends, thereby preserving brand alignment in a dynamic environment.

As another example, the continuous evolution of the design system may be based on updates to one or more aspects of system 200. These aspects may include user inputs, presets or packs, prebuilt webpage sections, prompts provided to a machine learning model, or the model itself. System 200 may maintain a relevant and effective design system over time, all without requiring a user to manually track and implement changes based on performance data or industry trends, thereby preserving brand alignment in a dynamic environment. Other methods for the evolution of a design system are also possible.

FIG. 3 illustrates an example of a user interface 300 for generating content for webpage components in a webpage in response to a user request, according to semantic similarity, using one or more machine learning models and a content management system. In this example, the content generation process for webpage components operates through a coordinated data pipeline architecture. In one pipeline, the system extracts a semantic hierarchy within the CMS based on the vectorized representation of the user request data. This pipeline identifies relationships among webpage components and establishes the hierarchical framework that guides downstream content generation. In a parallel or subsequent pipeline, the system generates prompt data that is dynamically tailored to the user request data and the identified semantic hierarchy. The prompt data is then provided as input to one or more ML models configured to generate output content for populating the corresponding webpage components. The resulting content is semantically consistent and coherent with the structure, abstraction level, and relationships of the webpage components according to the semantic hierarchy.

As shown in FIG. 3, when a user of the controller device 303 sends the request data entered by a user of the controlling device 301 for generating content for webpage components on a website, the system may process the user request data in the background process according to the semantic hierarchy as described above. After obtaining ML-generated content following instructions prescribed in prompt data generated based on user request and the identified semantic content, the system generates and transmits the instructions to the controlling device 301 to cause the controlling device 301 to display or present a user interface 300. The user interface 300 presents a representation of one or more generated content populated into corresponding locations or places of webpage components according to requirements specified in the user request data.

As illustrated in FIG. 3, a user interface 300 may present a webpage representing multiple sections, at least some of which are populated with different types of content generated by the backend processes described above in connection with FIG. 1. For example, the user interface 300 may display one or more heading sections 311. The heading sections 311 generally correspond to a higher level of the semantic hierarchy, characterized by a high degree of abstraction and lower complexity. For instance, the headings may include section titles such as “Product Overview,” “Features,” or “About the Brand,” or other content with a higher level of abstraction.

For each heading 311, the user interface 300 may display one or more associated sections at a lower level of the semantic hierarchy. As shown in FIG. 3, these may include a first section 313 containing textual content generated by one or more ML models in accordance with the semantic hierarchy. Because this section occupies a lower hierarchical level than the heading section, the generated text may be longer, more detailed, and more descriptive, which generally expands on the topics introduced by the heading section 311. One or more of these sections may also include groups of visual content generated by the ML models in response to the user request. For example, the user interface 300 may include a first visual content item 315, a second visual content item 317, and a third visual content item 319, each visually representing a distinct aspect or view of the topic associated with the heading 311 and the corresponding textual content 313. As a concrete example, a heading 311 may correspond to a specific product featured on the webpage. The textual content 313 may provide a narrative or descriptive overview of that product, and the visual content items 315, 317, and 319 may depict images of the product from different perspectives, such as front, side, and top views.

The user interface 300 may also include additional sections of various types, each representing a different semantic level. For example, as shown in FIG. 3, the user interface 300 may include a first section 321 corresponding to a pricing section. The title of the section 321 resides at a higher semantic hierarchy level, while a subsection 325 positioned below it may present multiple price entries or product plan options. The subsection 325 generally resides at a lower semantic hierarchy level and therefore the generated content from ML-models provides more detailed description for the individual prices or plan structures. For instance, the section 321 may represent a pricing overview for a wireless communication service, while the subsections 325 specify pricing tiers for individual service plans such as “Basic,” “Plus,” or “Premium.”

As another example, the user interface 300 may include a section 331 corresponding to a user testimonial section. The section title 331 may occupy a higher level in the semantic hierarchy, while individual testimonial entries 335 occupy lower levels of the hierarchy. Each testimonial 335 may represent a user's feedback or experience associated with the product or service provided by the website. Those testimonials may be retrieved from CMS, and/or modified or generated using ML models based on available user input or existing testimonial data.

It should be understood that the webpage may include various webpage components or sections, each associated with several subordinate sections or subsections that contain various types of content generated by ML models according to their respective semantic hierarchies. The numbers, structures, and content types of headings, sections, and subsections illustrated in FIG. 3 are merely exemplary. Other configurations (e.g., different hierarchical depths, component types, or combinations of textual, visual, and interactive content) may likewise be used within the scope of the disclosed techniques. Hierarchical relationships may reflect relationships between individual sections or across multiple sections. The semantic hierarchy among webpage components may vary depending on the structure of the webpage, the type of content being generated, or user-defined design preferences. In some implementations, certain sections may include multiple nested subsections of varying hierarchical depths, while in other implementations, sections at similar hierarchy levels may be semantically linked through cross-references or shared contextual attributes. Accordingly, the hierarchical organization illustrated and described herein is provided for explanatory purposes only, and other configurations, depths, or interrelationships among webpage components may likewise be implemented within the scope of this disclosure.

The user interface 300 may include a vertical section 303 providing tools for webpage design. Examples of these tools include a drag-and-drop editor for adding and rearranging sections, a real-time style editor for adjusting fonts, color palettes, and responsive breakpoints, and media integration tools for embedding images, videos, or interactive widgets, or other suitable design tools. In some implementations, the user may also invoke intelligent assistants to suggest layouts or auto-populate sections based on minimal input. In some other implementations, the system may provide a coding interface so that the user instructs the system on the requirements related to webpage generation using user-specified code. In some other implementations, the tool section 303 may include functionality for uploading or inputting user-provided materials such as images, text, videos, or other media assets, which may then be incorporated into the generated webpages.

The fourth user interface 350 may include a variety of interactive elements that enable the user to refine, adjust, or regenerate selected content populated within respective webpage components of the generated webpage. For example, a user operating the controlling device 301 may select one or more generated content items and request the system to regenerate or modify the selected content based on updated user requirements. As shown in FIG. 3, the user interface 300 may include a guidance interface 381 configured to provide step-by-step assistance for modifying or regenerating ML-generated content. The guidance interface 381 may prompt the user to select a particular content item for modification and, upon selection, display a message such as “Let's rewrite this for you.” The user may then enter specific regeneration requirements, instructions, or revised text within an input text box 383. In some implementations, the user may directly edit or overwrite the selected content in the input text box 383. In other implementations, the interface may provide selectable menus or contextual toolbars that allow the user to choose, delete, or modify specific portions of content, or to exclude selected elements entirely from the corresponding webpage components.

Upon clicking the regenerate button 385, the controlling device 301 sends the new user request data for content generation according to the semantic hierarchy. The user is enabled to iteratively update or modify generated content until satisfaction is achieved. The backend process for each iteration substantially follows a similar backend process described above.

In some implementations, the user interface 300 may also provide additional design customization tools that allow the user to modify the generated content of the webpage. Such tools may include theme selectors for applying new visual themes to the webpage, color customization panels, and style adjustment controls for modifying visual elements such as button shapes, borders, or backgrounds. Other customization options may include font selection tools, image replacement utilities, layout adjustment features, and accessibility settings that adapt webpage content for different viewing preferences or compliance requirements. These user interface features collectively enable both semantic and visual refinement of the generated webpage, allowing the user to achieve a coherent, customized design consistent with their intended presentation and user experience.

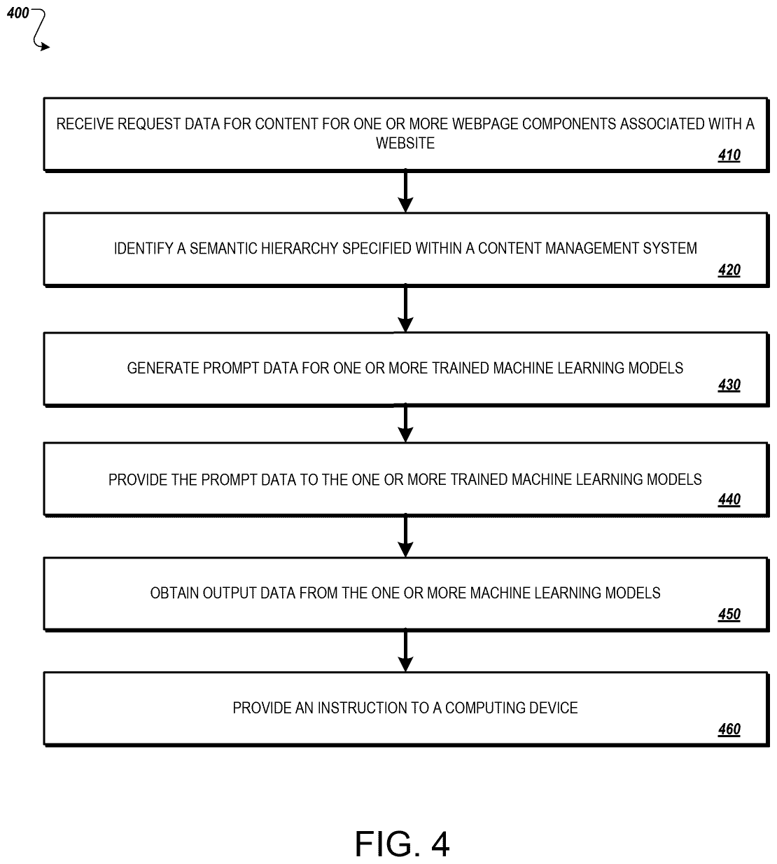

FIG. 4 illustrates a flow chart for an example of a process 400 for generating content for webpage components in a webpage in response to a user request, according to semantic similarity, using one or more ML models and a content management system. The operations of the example process 400 may be performed by one or more systems, e.g., system 200 of FIG. 2 or one or more elements of system 200. The process 400 may be executed by system 200 further in relation to the technique shown in FIG. 1. For example, application 152A on controller device 102 transmits a user request data captured from input box 166. The server(s) 110 may process the user request 104 (and optionally context data 106) to identify the semantic hierarchy 116 within the CMS 120, and generate prompt data based on the user request data 104 and the semantic hierarchy 116 as input for one or more ML models to generate webpage content.

The hosting system 140 may provide raw output data 114 generated by one or more ML models 142 to server(s) 110 to populate one or more webpages. The raw output data 114 may include various types of content that are semantically consistent with the corresponding webpage components. The types of content may include textual, visual, audio, or other suitable content. The one or more ML models 142 may include various types of ML models, e.g., multi-modal autoencoders and/or autodecoders, LLMs, or other suitable ML models. The server(s) 110 may merge the ML-generated content with the corresponding locations of one or more webpage components to generate instructions to be transmitted to the controller device 102. The instructions 102, including the processed output data 108, once transmitted to and executed by the controller device 102, cause the controller device 102 to display ML-generated content populated in corresponding locations of webpage components of a website or webpage.

More specifically, process 400 includes receiving, by a server system and from a computing device, request data for generating content for one or more webpage components associated with the website (410). As described above, a user request may include data specifying various requirements and preferences for content generation using one or more ML models. For example, the user request may define linguistic preferences for the generated content, such as tone, style, formality, or other linguistic attributes. As another example, the user request may specify the desired content types, including textual content, visual content, audio content, or combinations thereof. In some implementations, the user request may further define a semantic hierarchy among selected webpage components. For instance, the user may specify that a heading corresponds to a first-tier hierarchy, multiple sections correspond to a second-tier hierarchy relative to the heading and lower than the first-tier hierarchy, and one or more subsections correspond to a third-tier hierarchy and lower than the second-tier hierarchy.

In scenarios where the user explicitly specifies the semantic hierarchy among webpage components, the user-defined hierarchy may override the corresponding hierarchy previously defined within the CMS. Alternatively, the system may skip retrieving semantic hierarchy data from the CMS and instead rely on the hierarchy structure indicated directly in the user request. In some implementations, the CMS might still identify semantic hierarchy independent from the user's definition, and provide the retrieved hierarchy for the user's confirmation or selection before generating prompt data for ML models. This flexibility allows the user to maintain control over the structural relationships between webpage components while having a benchmark semantic hierarchical information identified from the CMS.

In some implementations, the system may receive user requirements for content generation through a guided, step-by-step intake interface presented on the controller device. The interface may include one or more text input fields, selectable options, or multiple-choice questions that collect structured information regarding user preferences, content tone, style, topic, or semantic hierarchy.

In some implementations, the one or more webpage components may include at least a first webpage component and a second webpage component. The first webpage component may include a heading corresponding to a section of the webpage associated with the website. For example, the heading may refer to a title or topic label that introduces the subject matter of the section. The second webpage component may include a body of text associated with the same section, providing detailed discussion, explanation, or elaboration of the topic introduced by the heading. In such configurations, the heading generally corresponds to a higher semantic hierarchy level than the associated body of text, as discussed above.

The process 400 further includes identifying, by the server system, a semantic hierarchy specified within the CMS based on the received user requirements (420). In general, the semantic hierarchy defines the semantic relationships among various webpage components, such as sections, subsections, and other suitable structural elements of the webpage. These relationships may represent interdependencies, logical associations, or cross-references between sections or subsections, thereby defining how content at different levels of abstraction relates to one another within the overall webpage architecture.

In some implementations, the semantic hierarchy may be represented as a graph-based data structure specifying hierarchical relationships among the one or more webpage components. The graph-based representation may include, for example, a tree structure in which parent nodes represent higher-level components (e.g., page headings or section titles) and child nodes represent subordinate components (e.g., subsections or content bodies associated with those headings). In another example, the semantic hierarchy may take the form of a directed acyclic graph (DAG) that captures more complex semantic dependencies or shared references among webpage components, such as when multiple subsections contribute to or inherit attributes from a common parent section.

The semantic hierarchy may include multiple semantic tiers, each representing a distinct level of abstraction among the webpage components. A first semantic tier may be associated with a first webpage component, while a second semantic tier may be associated with a second webpage component. The first semantic tier generally corresponds to a higher level of abstraction or conceptual generality than the second semantic tier. For example, the first semantic tier may relate to webpage headings, titles, or overarching thematic categories, whereas the second semantic tier may correspond to sections or subsections that are subordinate to and provide additional detail regarding the content of those headings, as described above. In some implementations, additional lower tiers may be defined to represent granular elements such as individual paragraphs, captions, or metadata attributes.

To identify the semantic hierarchy within the CMS, the system may embed at least a portion of the user request data into a vector representation within a semantic embedding space. The system may then determine multiple semantic similarity scores by comparing the vector representation of the user request data with multiple vector representations corresponding to content chunks stored in the CMS. Each stored content chunk may include associated semantic metadata indicating its hierarchy level, contextual meaning, or relationship to other webpage components. The system may select the semantic information corresponding to the content chunks that exhibit semantic similarity scores exceeding a predefined threshold value as the semantic hierarchy.

In some implementations, the semantic similarity scores may be determined based on distances between vector representations in the embedding space. The distance metric may take various forms depending on the similarity function used. For example, the system may define the distance as the Euclidean distance (L2 norm), which represents the straight-line distance between two points in the vector space. In another example, the system may define the distance as the Manhattan distance (L1 norm), which corresponds to the sum of absolute differences along each coordinate axis. In yet another example, the system may use cosine similarity, which measures the cosine of the angle between two vectors, thereby capturing directional similarity independent of magnitude.

Based on the computed similarity scores, the system may identify and select one or more content chunks whose semantic hierarchy levels correspond most closely to the user request data. For instance, the system may select the semantic hierarchy associated with the content chunks having the highest similarity scores or, alternatively, those exceeding a predetermined similarity threshold. The resulting semantic hierarchy is then used to guide prompt generation for ML models and content synthesis for the requested webpage components.

Process 400 includes generating, by the server system, prompt data for one or more trained ML models (430). The prompt data may include one or more instructions for generating output data corresponding to the one or more webpage components in accordance with the identified semantic hierarchy. In some implementations, these instructions may specify parameters or constraints that guide the ML model's generation process, such as desired complexity, level of abstraction, tone, or content length, based on the semantic relationships defined within the hierarchy. For example, an instruction may indicate that content generated for heading components should reflect a higher semantic tier, exhibiting greater abstraction and brevity, than the content generated for body text components associated with those headings, which may require more detailed, context-rich descriptions.

Process 400 includes providing, by the server system, the prompt data to the one or more trained ML models (440). The ML models process the prompt data to produce output content that may be fused with corresponding webpage components in accordance with the semantic hierarchy, as described above.

In some implementations, one or more trained ML models may include a multimodal ML model, which includes a multimodal encoder and a multimodal decoder. The multimodal encoder is configured to integrate heterogeneous inputs (e.g., text, images, metadata) into a shared latent space, and the multimodal decoder is configured to generate outputs from the projected inputs in the shared latent space according to prompt requirements. In some implementations, the ML models may also include large language models (LLMs) for natural language generation, or large action models (LAMs) for predicting structural or layout-related actions, or both, as described above.

Process 400 includes obtaining, by the server system and from one or more trained ML models, the output data (450). The output data may include one or more content items, each associated with a particular webpage component of one or more webpage components. The various content items are each further semantically consistent with the corresponding one or more webpage components, as described above.

In some implementations, the content items may include various types, e.g., text, images, layout suggestions, or other multimodal content generated in response to the prompt data, as described above. More specifically, the textual content may include headings, body text, product descriptions, or calls to action. For example, a “testimonial section” may be populated with various types of content, e.g., user quotes, user images and/or videos, profile images, or other suitable content, while a “pricing section” may be filled with tiered descriptions and numerical data.

In some implementations, the server system may further evaluate multiple content items included in the output data to determine whether the output data is valid based on one or more validation criteria. The system may include a validation module configured to assess the generated content items using various analytical techniques. For example, the system may determine a complexity indicator associated with each generated content item. The complexity indicator represents the relative complexity or abstraction level of the content and may be used to assess alignment with the semantic relationships defined in the semantic hierarchy.

If the complexity indicator for a content item satisfies a specified complexity requirement corresponding to its assigned semantic level, the system may determine that the content item is valid. Furthermore, if the number of valid content items exceeds a predefined threshold, the system may determine that the output data as a whole is valid. The complexity indicator may be expressed as a numerical value, categorical label, symbolic representation, or other suitable forms. The complexity indicator may be computed based on measurable characteristics such as content length, information density, syntactic depth, or conceptual granularity.

In another example, the system may determine a linguistic indicator associated with each generated content item and evaluate whether it satisfies a specified linguistic consistency requirement based on one or more semantic relationships defined in the semantic hierarchy. The linguistic indicator may reflect various linguistic features, such as coherence, tone, style, grammatical correctness, or overall fluency. If the linguistic indicator for a given content item meets the required consistency level, that content item may be deemed valid. Similarly, if the number of valid content items exceeds a threshold value, the system may determine that the output data as a whole meets the linguistic validity criteria.

The linguistic indicator may be represented as a numerical score, a symbolic marker, a categorical label, or other suitable forms. In some implementations, the linguistic indicator may be determined through natural language processing (NLP) models, rule-based grammar analysis, or style-matching algorithms that compare the generated content against reference samples or linguistic templates associated with the corresponding semantic hierarchy.

The system generally removes invalid output data from the data package to be transmitted to the computing device. In some implementations, the system may instruct the ML models to regenerate content data if the validation module deems the output data to be invalid according to the techniques described above.

Process 400 also includes providing, by the server system and to the computing device, an instruction responsive to the request data (460). When received and executed by the computing device, this instruction causes the computing device to render and display the generated content for the one or more webpage components.

In some implementations, the system may further enable the user to iteratively adjust the generated content displayed on the computing device. For example, the system may receive data indicating one or more user modifications to the displayed representation of the content data, such as edits, selections, or refinement commands. In response, the system may generate subsequent prompt data for one or more trained ML models based on the existing semantic hierarchy and the received user modifications. In some implementations, the system may update the semantic hierarchy or re-identify the semantic hierarchy based on the received user modifications. The subsequent prompt data may include one or more additional or updated instructions for regenerating or refining the content data in accordance with the user's input.

The system may then provide the subsequent prompt data to one or more trained ML models and obtain updated output data representing the modified content. Thereafter, the system may transmit a second instruction to the computing device which, upon execution, causes the computing device to display an updated or modified representation of the content data. This iterative feedback process enables the user to progressively guide the model's output toward the desired quality, tone, or structure, while maintaining semantic coherence across webpage components, as described above.

In some implementations, the system may receive feedback data representing one or more user actions associated with the displayed representation of the content data, and process the feedback data to generate additional prompt data for refining or regenerating the content. The feedback data may include explicit or implicit action signals, which are described in greater detail below. The system may process such feedback using various optimization or reinforcement techniques, including frameworks such as Gentrace or similar performance tracking systems, to iteratively improve the quality of ML-generated content.

The system may further analyze the feedback data to minimize placement errors, which refer to instances where a webpage component is infused with content that is semantically inconsistent with its hierarchical tier. For example, a placement error may occur when a detailed technical specification paragraph is generated for a heading component intended only to convey a concise product title. By continuously processing feedback data and adjusting subsequent prompt data, the system aims to minimize such placement inconsistencies and ensure that generated content remains semantically aligned with the webpage's hierarchical structure.

The feedback data may include a variety of signals. More specifically, these may include explicit action signals such as direct textual corrections, structured rating inputs, content selection or deselection actions, and edits made through the user interface. The feedback data may further include implicit action signals such as time spent editing or frequency of regeneration requests. In some implementations, the system may classify the feedback data by type, such as stylistic correction, factual adjustment, or structural modification, and apply various weighting schemes to prioritize certain forms of feedback when generating new prompt data.

In some implementations, the server system may also collect preference data from multiple computing devices, each providing information indicative of one or more user preferences or interaction patterns. The server system may aggregate these data points to generate composite or aggregate user preference data representing collective behavioral trends across users. Based on this aggregated preference data, the system may update or fine-tune the prompt data generation process in alignment with prevailing user preferences while maintaining semantic hierarchy integrity.

For example, if a statistically significant number of users consistently favor more concise heading text or prefer visual summaries over long descriptive paragraphs, the system may adjust subsequent prompt-generation templates, weighting parameters, or semantic complexity constraints to favor similar stylistic and structural outcomes in future content generation tasks.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification may be realized in digital electronic circuitry, in tangibly-embodied computer software or firmware, in computer hardware, including the structures disclosed in this specification and their structural equivalents, or in combinations of one or more of them. Implementations of the subject matter described in this specification may be implemented as one or more computer programs (e.g., one or more modules of computer program instructions) encoded on a tangible non-transitory storage medium for execution by, or to control the operation of, data processing apparatus. The computer storage medium may be a machine-readable storage device, a machine-readable storage substrate, a random or serial access memory device, or a combination of one or more of them. The program instructions may be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus may also be, or further include special purpose logic circuitry (e.g., an FPGA (field programmable gate array) or an ASIC (application-specific integrated circuit)). The apparatus optionally includes, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, may be written in any form of programming language, including compiled or interpreted languages, or declarative or procedural languages; and it may be deployed in any form, including as a stand-alone program or as a module, component, subroutine, or other unit suitable for use in a computing environment. A program may, but need not, correspond to a file in a file system. A program may be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines may be installed and running on the same computer or computers.

The processes and logic flows described in this specification may be performed by one or more programmable computers executing one or more computer programs to perform functions by operating on input data and generating output. The processes and logic flows may also be performed by special purpose logic circuitry (e.g., a FPGA, an ASIC), or by a combination of special purpose logic circuitry and one or more programmed computers.

Computers suitable for the execution of a computer program may be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory may be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification may be provisioned on a computer having a display device (e.g., a CRT (cathode ray tube) or LCD (liquid crystal display) monitor) for displaying information to the user and a keyboard and a pointing device (e.g., a mouse, a trackball), by which the user may provide input to the computer. Other kinds of devices may be used to provide for interaction with a user as well; for example, feedback provided to the user may be any form of sensory feedback (e.g., visual feedback, auditory feedback, tactile feedback); and input from the user may be received in any form, including acoustic, speech, or tactile input. In addition, a computer may interact with a user by sending documents to and receiving documents from a device that is used by the user; for example, by sending web pages to a web browser on a user's device in response to requests received from the web browser. Also, a computer may interact with a user by sending text messages or other forms of message to a personal device (e.g., a smartphone that is running a messaging application), and receiving responsive messages from the user in return.

Data processing apparatus for implementing ML models may also include, for example, special-purpose hardware accelerator units for processing common and compute-intensive parts of ML training or production (e.g., inference, workloads).

ML models may be implemented and deployed using a ML framework (e.g., a TensorFlow framework, a Microsoft Cognitive Toolkit framework, an Apache Singa framework, an Apache MXNet framework).

Implementations of the subject matter described in this specification may be realized in a computing system that includes a back-end component (e.g., as a data server) a middleware component (e.g., an application server), and/or a front-end component (e.g., a client computer having a graphical user interface, a web browser, or an app through which a user may interact with implementations of the subject matter described in this specification), or any combination of one or more such back-end, middleware, or front-end components. The components of the system may be interconnected by any form or medium of digital data communication (e.g., a communication network). Examples of communication networks include a local area network (LAN) and a wide area network (WAN) (e.g., the Internet).

The computing system may include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) may be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially be claimed as such, one or more features from a claimed combination may in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems may generally be integrated together in a single software product or packaged into multiple software products.

Particular implementations of the subject matter have been described. Other implementations are within the scope of the following claims. For example, the actions recited in the claims may be performed in a different order and still achieve desirable results. As one example, the processes depicted in the accompanying figures do not necessarily require the particular order shown, or sequential order, to achieve desirable results. In some cases, multitasking and parallel processing may be advantageous.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving, by a server system and from a computing device, request data for content for one or more webpage components associated with the website;
identifying, by the server system and based on the request data, a semantic hierarchy specified within a content management system for the one or more webpage components;
generating, by the server system and based on the semantic hierarchy, prompt data for one or more trained machine learning (ML) models, wherein the prompt data comprises one or more instructions for generating content data corresponding to the one or more webpage components according to the semantic hierarchy;
providing, by the server system, the prompt data to the one or more trained ML models;
obtaining, by the server system and from the one or more trained ML models, output data for the content data; and
providing, by the server system and to the computing device responsive to the request data, an instruction that, when received by the computing device, causes the computing device to display a representation of the content data.

2. The method of claim 1, wherein the one or more instructions comprise an instruction specifying a desired complexity for the content data based on one or more semantic relationships specified in the semantic hierarchy.

3. The method of claim 2, wherein:
the output data comprises a plurality of content items that are each associated with a particular webpage component included in the one or more webpage components; and
the method further comprises:
evaluating, by the server system, the plurality of content items of the output data; and
determining, by the server system, that the output data is valid based on evaluating the plurality of content items.

4. The method of claim 3, wherein:
evaluating the plurality of content items of the output data comprises determining a complexity indicator associated with each content item included in the plurality of content items; and
determining that the output data is valid comprises determining that complexity indicators determined for content items included in the plurality of content items satisfies a specified complexity based on one or more semantic relationships specified in the semantic hierarchy.

5. The method of claim 3, wherein:
evaluating the plurality of content items of the output data comprises determining a linguistic indicator associated with each content item included in the plurality of content items; and
determining that the output data is valid comprises determining that linguistic indicators determined for content items included in the plurality of content items satisfies a specified consistency based on one or more semantic relationships specified in the semantic hierarchy.

6. The method of claim 5, wherein the linguistic indicator comprises a tone indicator.

7. The method of claim 1, further comprising:
receiving, by the server system, data indicating one or more user modifications to the representation of the content data;
generating, by the server system and based on the semantic hierarchy, second prompt data for the one or more trained ML models, wherein the second prompt data comprises one or more additional instructions for generating the content data based on the one or more user modifications;
providing, by the server system, the second prompt data to one or more trained ML models;
obtaining, by the server system and from the one or more trained ML models, second output data for the content data; and
providing, by the server system and to the computing device, a second instruction that, when received by the computing device, causes the computing device to display a modified representation of the content data.

8. The method of claim 1, wherein:
the semantic hierarchy comprises a plurality of semantic tiers;
a first semantic tier is associated with a first webpage component;
a second semantic tier is associated with a second webpage component; and
the first semantic tier represents semantic information at a higher level of abstraction than the second semantic tier.

9. The method of claim 8, wherein:
the first webpage component comprises a heading for a section of a webpage associated with the website; and
the second webpage component comprises a body of text for the section.

10. The method of claim 1, wherein the semantic hierarchy comprises a graph-based representation specifying hierarchical relationships among the one or more webpage components.

11. The method of claim 1, further comprising:
embedding, by the server system, at least a portion of the request data into a vector representation;
determining, by the server system, a plurality of semantic similarity scores by comparing the vector representation to a plurality of vector representations corresponding to a plurality of content chunks stored in the content management system; and
selecting, by the server system, as the semantic hierarchy, semantic information of the content chunks with semantic similarity scores higher than a threshold value.

12. The method of claim 1, further comprising:
receiving, by the server system, feedback data representing a user action associated with the displayed representation of the content data; and
processing, by the server system, the feedback data used for generating additional prompt data.

13. A system comprising one or more computers and one or more storage devices storing instructions that, when executed by one or more computers, cause the one or more computers to perform respective operations, the operations comprising:
receiving, by a server system and from a computing device, request data for content for one or more webpage components associated with the website;
identifying, by the server system and based on the request data, a semantic hierarchy specified within a content management system for the one or more webpage components;
generating, by the server system and based on the semantic hierarchy, prompt data for one or more trained machine learning (ML) models, wherein the prompt data comprises one or more instructions for generating content data corresponding to the one or more webpage components according to the semantic hierarchy;
providing, by the server system, the prompt data to the one or more trained ML models;
obtaining, by the server system and from the one or more trained ML models, output data for the content data; and
providing, by the server system and to the computing device responsive to the request data, an instruction that, when received by the computing device, causes the computing device to display a representation of the content data.

14. The system of claim 13, wherein the one or more instructions comprise an instruction specifying a desired complexity for the content data based on one or more semantic relationships specified in the semantic hierarchy.

15. The system of claim 14, wherein:
the output data comprises a plurality of content items that are each associated with a particular webpage component included in the one or more webpage components; and
the method further comprises:
evaluating, by the server system, the plurality of content items of the output data; and
determining, by the server system, that the output data is valid based on evaluating the plurality of content items.

16. The system of claim 13, wherein the operations further comprise:
receiving, by the server system, data indicating one or more user modifications to the representation of the content data;
generating, by the server system and based on the semantic hierarchy, second prompt data for the one or more trained ML models, wherein the second prompt data comprises one or more additional instructions for generating the content data based on the one or more user modifications;
providing, by the server system, the second prompt data to one or more trained ML models;
obtaining, by the server system and from the one or more trained ML models, second output data for the content data; and
providing, by the server system and to the computing device, a second instruction that, when received by the computing device, causes the computing device to display a modified representation of the content data.

17. One or more computer-readable storage media storing instructions that, when executed by one or more computers, cause the one or more computers to perform respective operations, the respective operations comprising:
receiving, by a server system and from a computing device, request data for content for one or more webpage components associated with the website;
identifying, by the server system and based on the request data, a semantic hierarchy specified within a content management system for the one or more webpage components;
generating, by the server system and based on the semantic hierarchy, prompt data for one or more trained machine learning (ML) models, wherein the prompt data comprises one or more instructions for generating content data corresponding to the one or more webpage components according to the semantic hierarchy;
providing, by the server system, the prompt data to the one or more trained ML models;
obtaining, by the server system and from the one or more trained ML models, output data for the content data; and
providing, by the server system and to the computing device responsive to the request data, an instruction that, when received by the computing device, causes the computing device to display a representation of the content data.

18. The one or more computer-readable storage media of claim 17, wherein the one or more instructions comprise an instruction specifying a desired complexity for the content data based on one or more semantic relationships specified in the semantic hierarchy.

19. The one or more computer-readable storage media of claim 18, wherein:
the output data comprises a plurality of content items that are each associated with a particular webpage component included in the one or more webpage components; and
the method further comprises:
evaluating, by the server system, the plurality of content items of the output data; and
determining, by the server system, that the output data is valid based on evaluating the plurality of content items.

20. The one or more computer-readable storage media of claim 17, wherein the operations further comprise:
receiving, by the server system, data indicating one or more user modifications to the representation of the content data;
generating, by the server system and based on the semantic hierarchy, second prompt data for the one or more trained ML models, wherein the second prompt data comprises one or more additional instructions for generating the content data based on the one or more user modifications;
providing, by the server system, the second prompt data to one or more trained ML models;
obtaining, by the server system and from the one or more trained ML models, second output data for the content data; and
providing, by the server system and to the computing device, a second instruction that, when received by the computing device, causes the computing device to display a modified representation of the content data.
